(19) United States
(12) Patent Application Publication
(10) Pub. No.: US 2015/0103367 A1
(43) Pub. Date: Apr. 16, 2015

(54) PRINTING SYSTEM, MOBILE TERMINAL, PRINTING APPARATUS, MOBILE TERMINAL CONTROL METHOD, PRINTING APPARATUS CONTROL METHOD, AND STORAGE MEDIUM

(71) Applicant: CANON KABUSHIKI KAISHA, Tokyo (JP)

(72) Inventor: Kosuke Tsujita, Tama-shi (JP)

(21) Appl. No.: 14/511,053

(22) Filed: Oct. 9, 2014

(30) Foreign Application Priority Data
Oct. 11, 2013 (JP) 2013-213595

(51) Int. Cl. G06F 3/12; H04N 1/21; G06K 15/02; H04N 1/387; H04N 1/00; G06K 15/00

(52) U.S. Cl. CPC G06F 3/1242; H04N 1/00307; H04N 1/00347; G06K 15/005; G06K 15/021; G06K 15/181; G06F 3/1253; H04N 1/0057; H04N 1/00411; H04N 1/00408; H04N 1/387; H04N 1/21; H04N 2201/0094
USPC 358/1.13

(57) ABSTRACT

A printing system enables a user of a mobile terminal to confirm a print result to be printed on a pre-printed paper that can be fed from a specific paper feeding unit provided in a printing apparatus. A method for controlling the printing apparatus includes generating print data to be printed based on a print job received from the mobile terminal, generating composite image data by combining the generated print data with image data of a pre-printed paper transmitted from the mobile terminal, and transferring the generated composite image data to the mobile terminal.

### BACKGROUND OF THE INVENTION

1. Field of the Invention

The present invention relates to a printing system, a mobile terminal, a printing apparatus, a mobile terminal control method, a printing apparatus control method, and a storage medium.

2. Description of the Related Art

Improving performances of a multi-function peripheral and enhancing various functions thereof leads to an increase of requirements in on-demand print services. Further, strongly required is increasing the number of paper types that the multi-function peripheral can process. Pre-printed paper is a representative example of the strongly required paper types. The pre-printed paper is a paper on which a predetermined image, text, pattern, or the like is printed beforehand. When a user wants to use such a pre-printed paper in a printing operation, the user sets a desired pre-printed paper in a paper feeding device provided in the multi-function peripheral and registers the stored pre-printed paper as a paper type of the paper feeding device beforehand. Subsequently, when the user operates a terminal apparatus to input a print job to the multi-function peripheral, the user can designate the registered pre-printed paper as a printing paper type so that the multi-function peripheral can start printing using the designated pre-printed paper. As discussed in Japanese Patent Application Laid-Open No. 2006-239929, as a pre-printed paper related function, it is conventionally known that a printing apparatus can combine a print image with a pre-printed paper beforehand and perform a preview of a printed result. The above-mentioned function includes reading an image printed on the pre-printed paper with a scanner and registering the read image (hereinafter, referred to as “pre-printed image”), as a paper type, to the printing apparatus. If a user selects the registered paper type in a printing operation, the printing apparatus superposes a print job image on a pre-printed image associated with the selected paper type and generates a preview image of a printed result. The above-mentioned function enables each user to confirm an image to be printed on the pre-printed paper beforehand.

A conventionally known pre-printed paper preview combination display function is not satisfactory in that the correspondence between a pre-printed image to be used in image combination processing and a paper feeding device and/or a setting direction is not taken into consideration. For example, it is now presumed that a user inputs a print job that uses a pre-printed paper whose pre-printed image is already registered. In this case, even when a displayed preview image is the one expected by the user, it may be difficult for the user to set a pre-printed paper in a suitable paper feeding device according to a correct setting direction to obtain a printed product corresponding to the preview image. The reading device generally used in a conventional pre-printed paper registration work is a scanner. However, the relationship between a pre-printed paper setting direction relative to the scanner and the setting direction of a pre-printed paper actually set in a paper feeding device is not taken into consideration. Even when the above-mentioned relationship can be presented to the user, a reading surface of the pre-printed paper may be directed to the ground side or, after the reading operation completes, the pre-printed paper may be turned upside down according to a reading method of the scanner. Therefore, it was difficult for the user to intuitively know the correct setting direction and the correct paper feeding device in which the pre-printed paper should be placed.

### SUMMARY OF THE INVENTION

According to an aspect of the present invention, in the printing system, a mobile terminal can communicate with a printing apparatus that includes a plurality of paper feeding units capable of storing pre-printed papers. The mobile terminal includes an imaging unit, a storage unit configured to store image data of a pre-printed paper captured by the imaging unit and stored in a paper feeding unit together with a print job to be printed, an acceptance unit configured to accept paper settings for the pre-printed paper via a display screen, a transmission unit configured to transmit the image data of the pre-printed paper stored in the storage unit, the paper settings for the pre-printed paper, and the print job to the printing apparatus, a reception unit configured to receive composite image data, which is obtained by combining the pre-printed paper image data with print data generated from the print job, from the printing apparatus, and a display control unit configured to display the composite image data received from the printing apparatus on a display screen. The printing apparatus includes a generation unit configured to generate print data to be printed based on a print job received from the mobile terminal, an image processing unit configured to generate composite image data by combining the print data generated by the generation unit with image data of a pre-printed paper transmitted from the mobile terminal, and a transfer unit configured to transfer the composite image data generated by the image processing unit to the mobile terminal.

Further features of the present invention will become apparent from the following description of exemplary embodiments with reference to the attached drawings.

### BRIEF DESCRIPTION OF THE DRAWINGS

FIG. 1 is a block diagram illustrating an example of a printing system.

FIG. 2 is a cross-sectional view illustrating a printing apparatus.

FIG. 3 illustrates a module configuration of the printing system.

FIG. 4A is a flowchart illustrating a printing system control method, FIG. 4B is a flowchart illustrating the printing system control method, and FIGS. 4C-A and 4C-B are flowcharts illustrating the printing system control method.

FIGS. 5A, 5B, 5C, and 5D illustrate operations that can be performed by the printing system.

FIG. 6 is a flowchart illustrating a printing system control method.

FIGS. 7A, 7B, 7C, 7D, and 7E illustrate operations that can be performed by the printing system.

FIG. 8 is a flowchart illustrating a printing system control method.

FIG. 9 illustrates a relationship between setting direction of a pre-printed paper to be set and an image.

FIGS. 10A, 10B, and 10C are flowcharts illustrating printing system control methods.

FIGS. 11A and 11B illustrate operations that can be performed by the printing system.

FIGS. 12A and 12B are flowcharts illustrating printing system control methods.

FIG. 13 illustrates operations that can be performed by the printing system.

FIGS. 14A, 14B, and 14C illustrate operations that can be performed by the printing system.

### DESCRIPTION OF THE EMBODIMENTS

Exemplary embodiments of the present invention will be described in detail below with reference to attached drawings.

### <System Configuration>

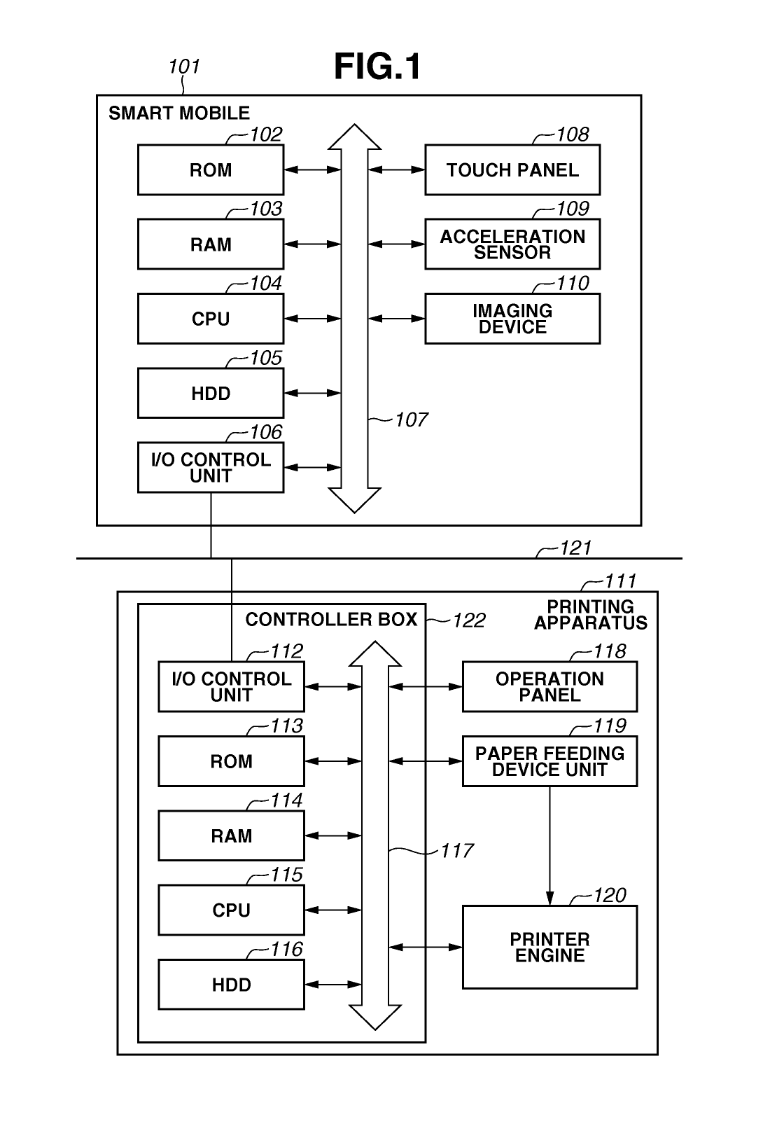

FIG. 1 is a block diagram illustrating an example of a printing system according to a first exemplary embodiment. The printing system according to the present exemplary embodiment includes a smart mobile device (hereinafter, referred to as “smart mobile”) 101 that can communicate with a printing apparatus 111. The smart mobile 101 is a mobile terminal (hereinafter, referred to as “portable terminal”). Further, the smart mobile 101 and the printing apparatus 111 are mutually connected via a communication line 121.

The printing system illustrated in FIG. 1 can include a plurality of smart mobiles, for example, used by numerous users. Further, the smart mobile 101 can be a smart mobile terminal, such as a PADPC or a smartphone. However, the smart mobile 101 may be a general information processing apparatus, such as a personal computer (PC) if the mobile terminal includes the following constituent components (see units 102 to 109). Hereinafter, the smart mobile 101 has the following configuration.

In FIG. 1, the smart mobile 101 can acquire user input information from an input apparatus (not illustrated) and generate a print job to be transmitted to the printing apparatus 111. Further, the smart mobile 101 can transmit the generated print job to the printing apparatus 111 via the communication line 121. Further, the smart mobile 101 can accept and display a print preview image when it is transmitted from the printing apparatus 111. Further, the smart mobile 101 can accept print parameter settings from a user and transmit a print job to the printing apparatus 111. An input/output (I/O) control unit 106 can perform a control to communicate with an external network. A read only memory (ROM) 102 stores various control programs. A random access memory (RAM) 103 can read a control program from the ROM 102 and store the read control program.

A central processing unit (CPU) 104 can execute each control program loaded into the RAM 103 and can perform an overall control for image signals and various devices. A hard disk drive (HDD) 105 can be used to temporarily or constantly store a large amount of image data and print data. A touch panel 108 enables a user to input various parameters relating to a print job and can be used to display print related information. An acceleration sensor 109 can accept a user input relating to a setting direction of a pre-printed paper. An imaging device 110 can capture an image of a pre-printed paper. The above-mentioned modules are mutually connected with each other via a system bus 107.

The printing apparatus 111 has the following configuration. The printing apparatus 111 can accept a print job transmitted from the smart mobile 101 and perform print processing according to the print job. Further, the printing apparatus 111 can accept print parameter settings from the smart mobile 101 and a pre-printed paper image. The printing apparatus 111 can generate a composite image of an image based on a print job with reference to the parameters and the image of the pre-printed paper. Further, the printing apparatus 111 can transmit the generated composite image data to the smart mobile 101. A controller box 122 can perform various kings of data processing and can control the printing apparatus 111 to perform various operations. An operation panel 118 can accept various operations from a user via a touch panel or an appropriate user interface (UI). A paper feeding device unit 119 is a paper storing device that includes a plurality of cassettes. Each cassette is capable of storing printing papers or pre-printed papers, which can be conveyed to a printer engine 120 in a printing operation. In this case, the paper conveyance direction is identical to either the short-side direction or the longitudinal direction of each fixed (or regular) size paper. Further, each user can input setting values with respect to the paper size and the paper direction for each cassette beforehand via the operation panel 118. The input setting values can be referred to when a database DB is generated as described in detail below.

The printer engine 120 can print image data on a printing paper and can output a printed product. The controller box 122 has the following configuration. An I/O control unit 112 can perform a control to communicate with an external network. A ROM 113 stores various control programs. A RAM 114 can read a control program from the ROM 113 and stores the read control program. A CPU 115 can execute each control program loaded into the RAM 114 to perform an overall control for image signals and various devices. A HDD 116 can be used to temporarily or constantly store a large amount of image data and print data. The above-mentioned modules are mutually connected via a system bus 117. Further, the system bus 117 connects the controller box 122 with each device in the printing apparatus 111 so that they can communicate with each other. The RAM 114 is functionally operable as a main memory or a work memory for the CPU 115. Further, the HDD 116 is usable to store the control programs and an operation system, instead of using the ROM 113.

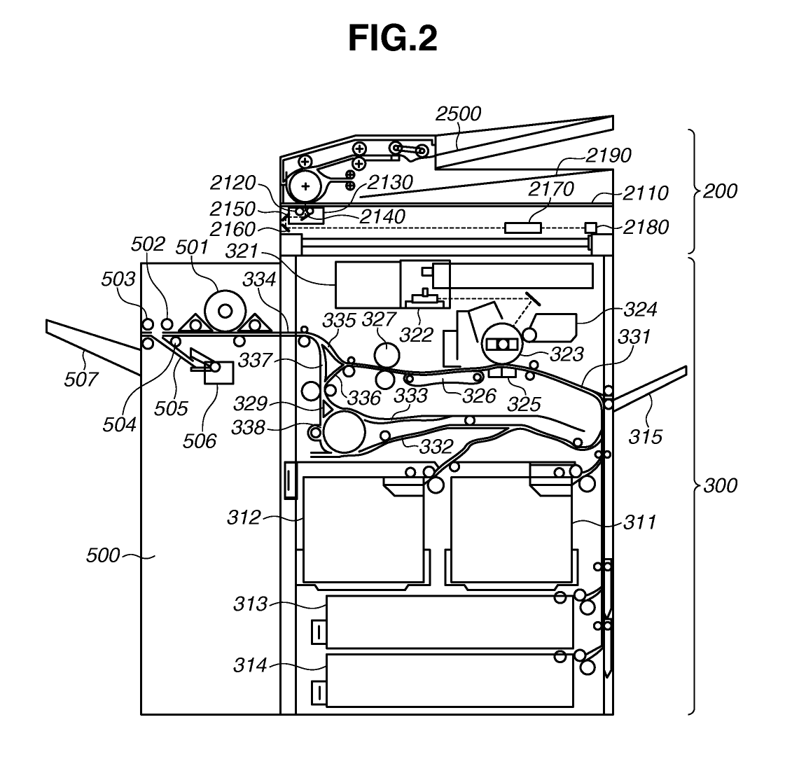

FIG. 2 is a cross-sectional view illustrating a configuration of the printing apparatus according to the present exemplary embodiment. In the present exemplary embodiment, a multi-function peripheral (MFP) having a printing function is an example of the printing apparatus. The printing apparatus according to the present exemplary embodiment has a configuration capable of storing various papers including pre-printed papers. Further, each paper can be fed in the longitudinal direction or the short-side direction. To this end, the printing apparatus includes a paper feeding unit configured to feed a paper in the longitudinal direction and a paper feeding unit configured to feed a paper in the short-side direction. In the printing apparatus according to the present exemplary embodiment, a relationship between a drum surface and a paper surface with respect to the image formation is set in such a manner that a non-printed surface of a pre-printed paper to be fed from the cassette is directed to the upper side, as described below.

In FIG. 2, a reader unit 200 includes a document feeding unit 250 that can successively feed documents one by one from a document table and convey the document to an optical unit 2130. The document, after passing through the optical unit 2130, can be discharged to a paper discharge tray 219. In a state where the document is positioned above the optical unit 2130, the reader unit 200 turns on a lamp 2120 of the optical unit 2130 to irradiate the document with light. In this case, reflection light from the document can be guided to a charge coupled device (CCD) image sensor (hereinafter, referred to as CCD) 218 via mirrors 2140, 215, and 216 and a lens 2170. A charge coupled device (CCD) 2180 can read an image of the document. The reader unit 200 performs predetermined processing on image data output from the CCD 2180 and transfers the processed image data to a control apparatus.

Further, the reader unit 200 can read an image of a document when a user places the document between the document feeding unit 250 and a platen glass 2110. In this case, the reader unit 200 turns on the lamp 2120 and causes the optical unit 2130 to move in a predetermined direction. In this case, reflection light from the document is guided to the CCD image sensor (hereinafter, referred to as CCD) 218 via the mirrors 2140, 215, and 216 and the lens 2170. Then, an image of the document is read by the CCD 2180. The reader unit 200 performs predetermined processing on image data output from the CCD 2180 and transfers the processed image data to the control apparatus 110.

A printer unit 300 includes a laser driver 321 that drives a laser emitting unit 322. More specifically, the laser driver 321 causes the laser emitting unit 322 to emit a laser beam according to image data output from an image memory 130 of the control apparatus 110. When the photosensitive drum 323 is irradiated with the laser beam, a latent image can be formed on the photosensitive drum 323 according to the laser beam. A development device 324 can supply developer that adheres to the latent image portion on the photosensitive drum 323.

Further, the printer unit 300 includes a plurality of cassettes 311 to 314 each having a drawer-like shape and a manual feeding tray 315, which are functionally operable as the paper feeding unit.

The printer unit 300 according to the present exemplary embodiment includes a plurality of cassettes that can store pre-printed papers, as described below. Each of the cassettes 311 to 314 is equipped with a sensor that can detect the presence of a sheet stored therein. Similarly, the manual feeding tray 315 is equipped with a sensor that can detect the presence of a sheet placed on the manual feeding tray 315.

The printer unit 300 can supply a sheet from any one of the cassettes 311 to 314 and the manual feeding tray 315, and then convey the sheet to a transfer unit 325 via a conveyance path 331. The transfer unit 325 can transfer the adhered developer from the photosensitive drum 323 to the sheet.

A conveyance belt 326 can convey the developer transferred sheet to a fixing unit 327. The fixing unit 327 can fix the developer on the conveyed sheet with heat and pressure applied thereon. Subsequently, after passing through the fixing unit 327, the sheet can be discharged to the outside via a conveyance path 335 and a conveyance path 334. When it is required to discharge a sheet with a print surface flipped upside down, the printer unit 300 guides the sheet to a conveyance path 338 via a conveyance path 336. Further, the printer unit 300 conveys the sheet in the opposite direction and can convey the sheet via a conveyance path 337 and the conveyance path 334.

Further, when the selected print mode is a two-sided print, the printer unit 300 causes a flapper 329 to guide a sheet to a conveyance path 333 via the conveyance path 336 after the sheet has passed through the fixing unit 327. Subsequently, the printer unit 300 conveys the sheet in the opposite direction and causes the flapper 329 to guide the sheet to a re-feeding conveyance path 332 via the conveyance path 338. The sheet being guided along the re-feeding conveyance path 332 passes through the conveyance path 331 at the above-mentioned timing and can be further conveyed until it reaches the transfer unit 325. The transfer unit 325 transfers the developer to a second surface of the sheet. Then, the printer unit 300 guides the sheet to the conveyance path 334 via the fixing unit 327. The sheet being guided along the conveyance path 334 can be conveyed to a finisher unit 500, regardless of the selected print mode (i.e., the one-sided print or the two-sided print).

The conveyed sheet is first sent to a buffer unit 501. In the present exemplary embodiment, the buffer unit 501 performs buffering by rolling the conveyed sheet around a buffer roller when needed. For example, if staple processing to be performed at a downstream side thereof requires a significant time, the buffer unit can adjust the conveyance interval of sheets successively conveyed from the main body of the printer unit 300. Subsequently, an upstream discharge roller pair 502 and a downstream discharge roller pair 503 cooperatively convey the sheet until the sheet is stacked on a stack tray 505 via a conveyance path 504. If the number of sheets stacked on the stack tray 505 is sufficient to constitute a complete sheet bundle composed of a predetermined number of sheets, the finisher unit 500 discharges the stacked sheet bundle to a paper discharge tray 507. If shifting each sheet bundle is designated, the finisher unit 500 offsets the sheet bundle stacked on the stack tray 505 from the position of the formally discharged sheet bundle. Therefore, it is easy for a user to discriminate each break point of the sheet bundle discharged to the paper discharge tray 507.

If the staple processing is designated, a sheet bundle is conveyed by the upstream discharge roller pair 502 and moved to the stack tray 505 by the downstream discharge roller pair 503 via the conveyance path 504. A staple unit 506 performs staple processing on the sheet bundle placed on the stack tray 505. Then, the stapled sheet bundle is discharged to the paper discharge tray 507 by the downstream discharge roller pair 503.

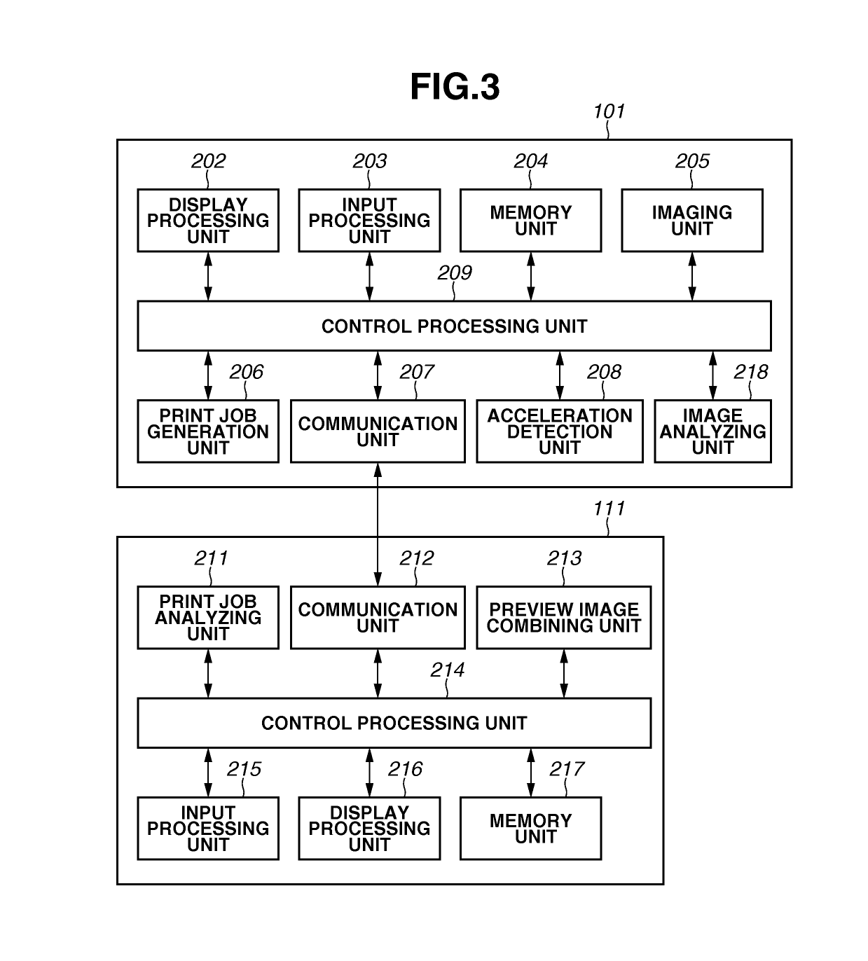

FIG. 3 is a block diagram illustrating a configuration of the smart mobile 101 illustrated in FIG. 1.

In FIG. 3, a print job generation unit 206 can acquire input information from a user via an input apparatus (not illustrated) and generate a print job to be transmitted to the printing apparatus 111. A display processing unit 202 can perform display processing for the print job generated by the print job generation unit 206, a preview image received from the printing apparatus 111, and a print setting item.

An input processing unit 203 can accept input processing of a user who has operated the touch panel 108. An imaging unit 205 can acquire an image captured by the imaging device 110. An acceleration detection unit 208 can detect a change in gravitational acceleration obtained by the acceleration sensor 109. An image analyzing unit 218 can extract a pre-printed paper area from an image captured by the imaging unit 205. A memory unit 204 can store the print setting item accepted by the input processing unit 203, the image captured by the imaging unit 205, the image of the pre-printed paper area extracted by the image analyzing unit 218, and the change in gravitational acceleration detected by the acceleration detection unit 208. A control processing unit 209 can control various operations of the above-mentioned functional units 202 to 208 and 218 based on the program.

In the printing apparatus 111, a print job analyzing unit 211 can analyze various print jobs accepted by the printing apparatus 111, including print jobs transmitted from the smart mobile 101. The print job analyzing unit 211 can read print setting information included in each print job. The print setting information includes information relating to printing paper size, print job enlargement rate, paper type, setting direction of pre-printed paper (one of paper types), paper storing device, and finishing setting. The print settings read by the print job analyzing unit 211 can be temporarily stored in an appropriate storage apparatus, such as the RAM 114 or the HDD 116. The input processing unit 215 can accept various inputs from an operator who operates the operation panel. The display processing unit 216 can display a print status.

A preview image combining unit 213 can combine a print job image and a pre-printed image based on a pre-printed paper setting direction. A memory unit 217 can store the pre-printed paper setting direction, the print job image, the pre-printed image, and the preview image combined by the preview image combining unit 213. A communication unit 212 can accept information relating to a print job and print settings transmitted from the smart mobile 101. Further, the communication unit 212 can transmit a preview image generated by the preview image combining unit 213 to the smart mobile 101. A control processing unit 214 can control various operations of the above-mentioned functional units 211 to 217 based on the program.

As a first example, it is presumed that print data of a generated print job is comparable to one page of “A4” size. The printing system performs printing on a plain paper of “A4” size (which is not any one of pre-printed papers) based on the print job data, as described below.

### <First Paper Setting Direction Determination Processing by Smart Mobile>

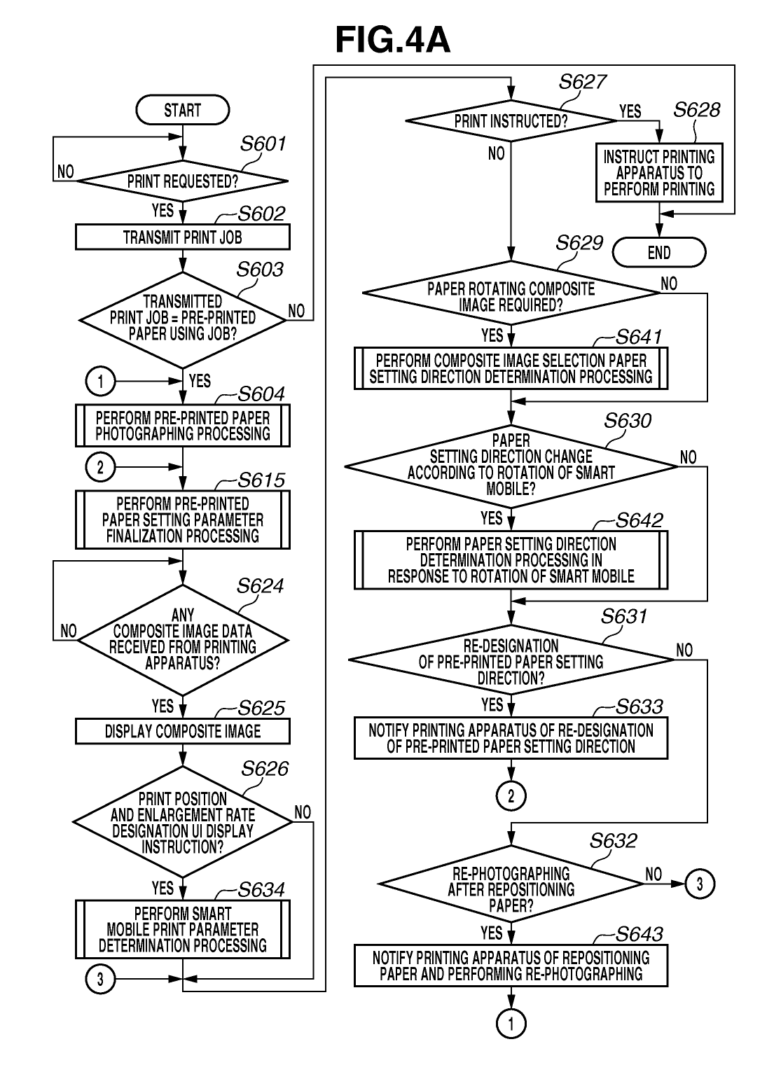

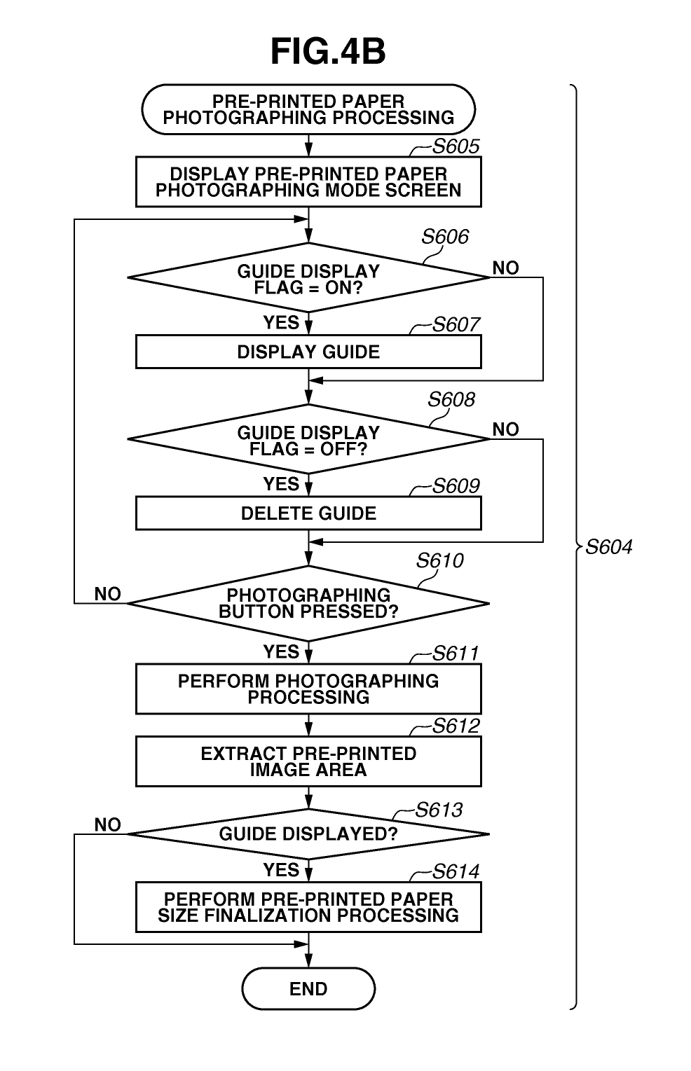

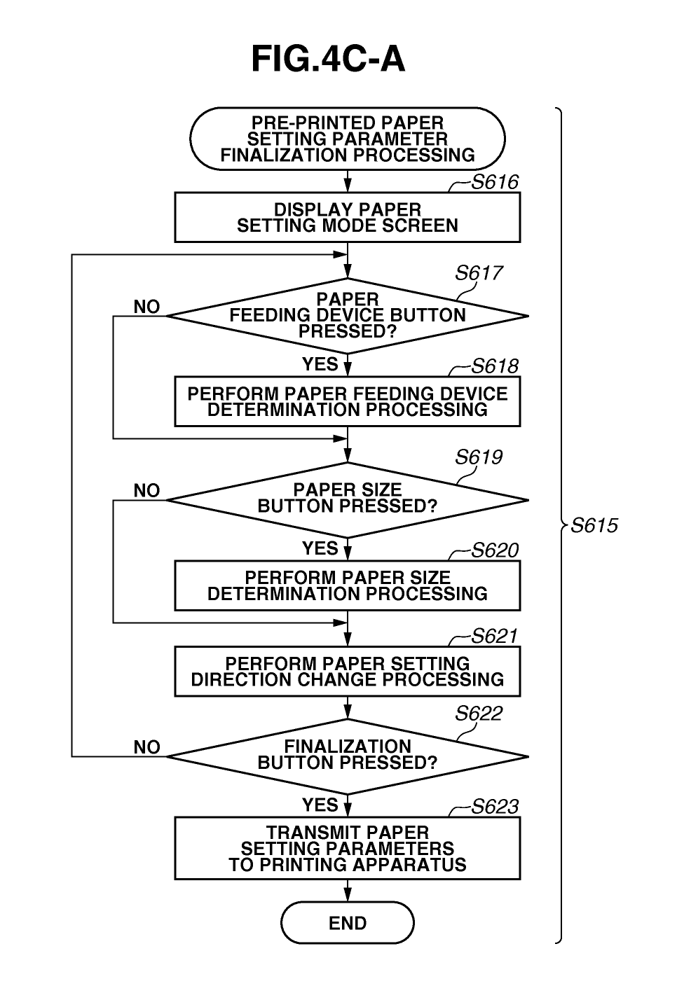

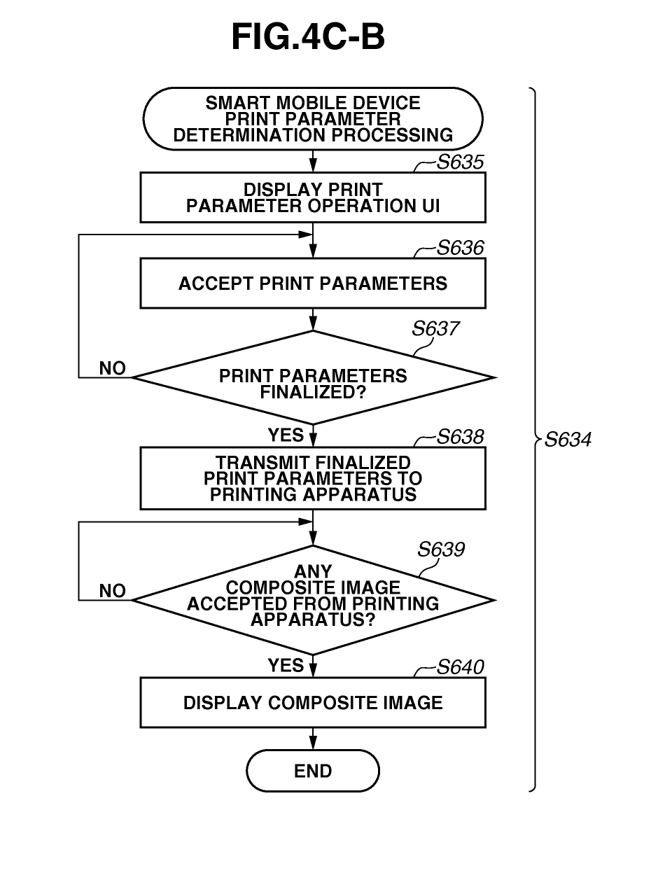

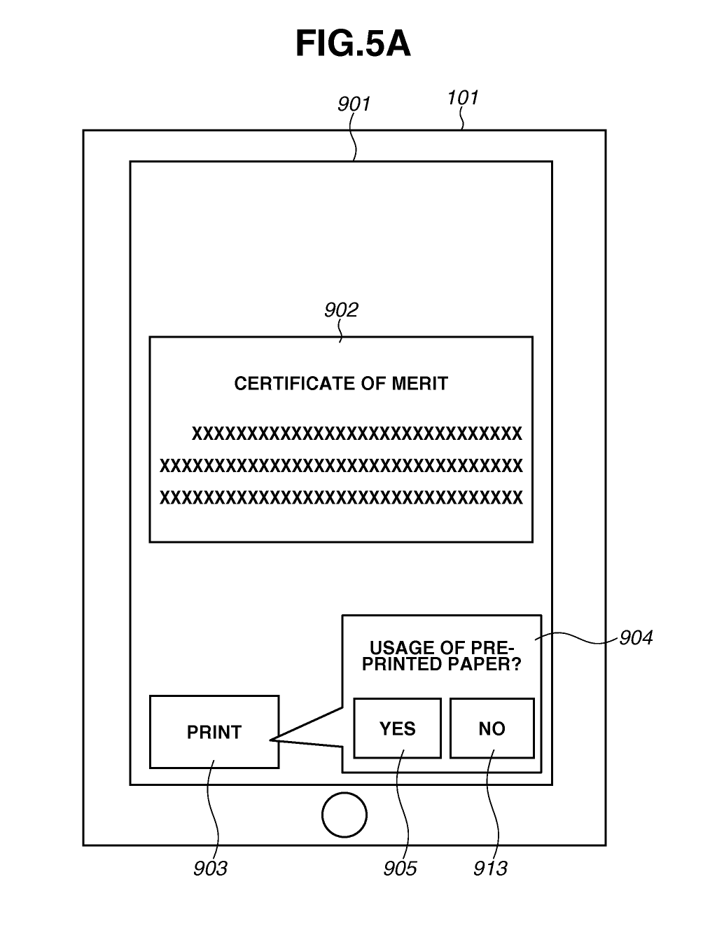

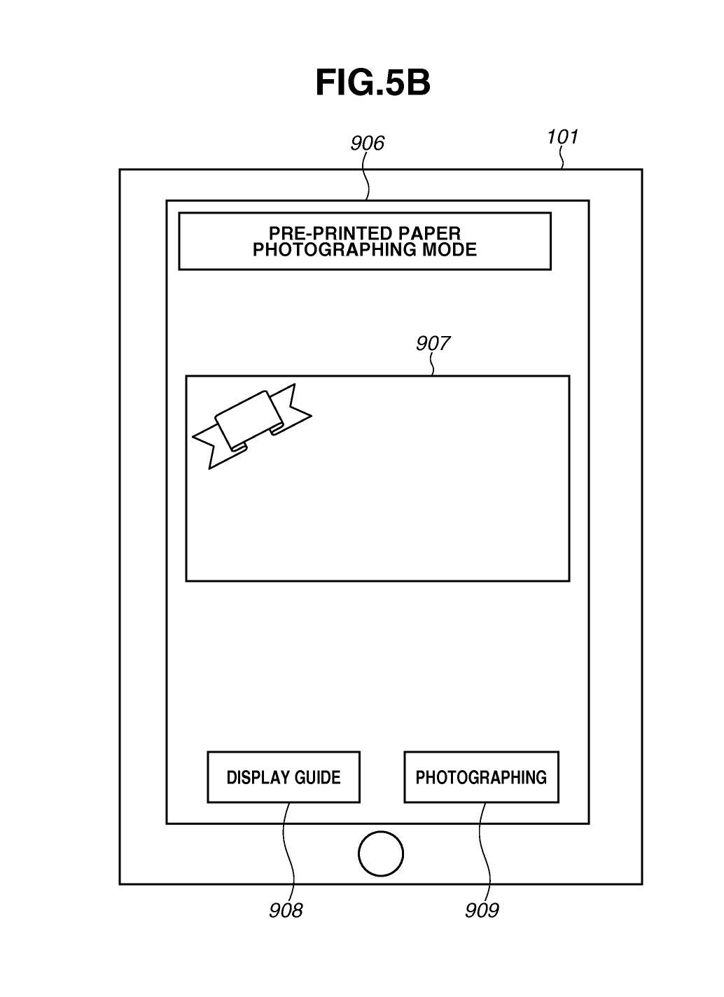

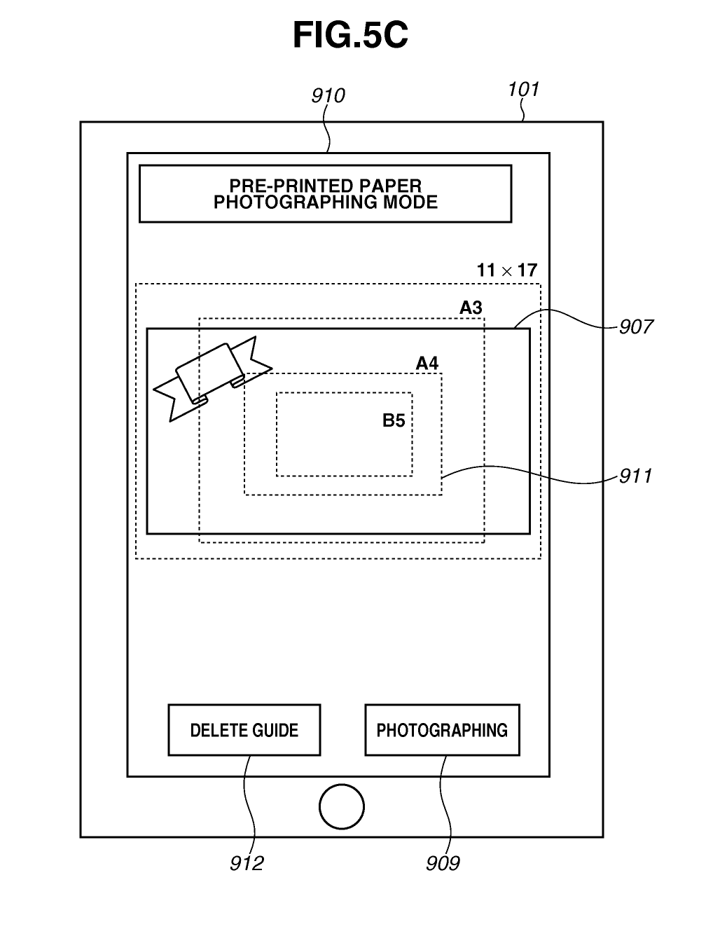

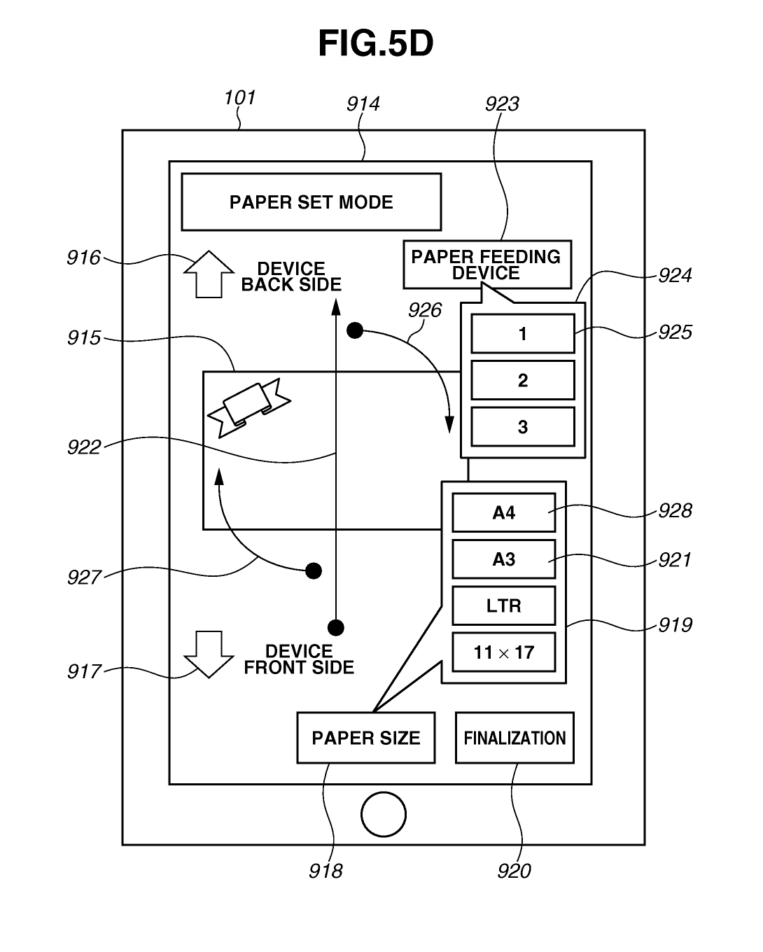

FIGS. 4A, 4B, 4C-A, and 4C-B are flowcharts illustrating a printing system control method according to the present exemplary embodiment. FIG. 4A illustrates data processing that can be performed by the information processing apparatus. FIG. 4B illustrates details of pre-printed paper photographing processing to be performed in step S604 of FIG. 4A. The smart mobile 101 performs first paper setting direction determination processing as described below. To realize the processing of the flowchart, the CPU 104 executes a program loaded from the ROM 102 into the RAM 103. UI screens illustrated in FIGS. 5A to 5D are used to describe the flowchart illustrated in FIG. 4A.

FIGS. 5A, 5B, 5C, and 5D illustrate UI screens that can be displayed on the touch panel 108 of the smart mobile 101 illustrated in FIG. 1. FIG. 5A illustrates an acceptance screen that is usable to accept paper settings including the usage of a pre-printed paper. FIG. 5B illustrates a pre-printed paper photographing mode screen that can be displayed according to the usage of the pre-printed paper designated on the screen illustrated in FIG. 5A. Further, FIG. 5C corresponds to the UI screen illustrated in FIG. 5B. FIG. 5D corresponds to a pre-printed paper request set mode screen.

FIG. 5A illustrates a print job input screen (i.e., a pre-printed paper (dedicated to a certificate of merit)) 901 that can be displayed on the touch panel 108. Information required to display the print job input screen 901 is stored in the memory unit 204. The display processing unit 202 displays the information on the touch panel 108 in response to an instruction from the control processing unit 209.

A print content 902 indicates the content of an object to be printed in a print job. The print content 902 can be displayed on the touch panel 108 when a user operates an input apparatus (not illustrated) to call a received print job or a print job stored in the memory unit 204.

A print start button 903 is functionally operable as a button that instructs the printing apparatus 111 to perform printing of the print job corresponding to the print content 902.

In step S601 illustrated in FIG. 4A, if a user presses the print start button 903 displayed on the touch panel 108, the control processing unit 209 performs a control in the following manner. The control processing unit 209 instructs the display processing unit 202 to display a selection screen 904 on the touch panel 108. The selection screen 904 enables the user to select the usage of a pre-printed paper as illustrated in FIG. 5A. Subsequently, if the user presses a NO button 913 on the selection screen 904, the control processing unit 209 accesses the memory unit 204 and writes information indicating that the print job does not use any pre-printed paper. Then, the processing proceeds to step S602.

In step S602, the control processing unit 209 reads print information corresponding to the print content 902 from the memory unit 204, and instructs the print job generation unit 206 to generate a print job. Further, the control processing unit 209 reads the information about the usage of no pre-printed paper in the print job from the memory unit 204. The control processing unit 209 instructs the communication unit 207 to transmit the generated print job together with the information about the usage of no pre-printed paper to the printing apparatus 111. Subsequently, in step S603, the control processing unit 209 accesses the memory unit 204 and determines whether the print job is a pre-printed paper using job. If it is determined that the print job does not use any pre-printed paper (NO in step S603), the control processing unit 209 terminates the processing of the flowchart illustrated in FIG. 4A.

### <First Paper Setting Direction Determination Processing by Printing Apparatus 111>

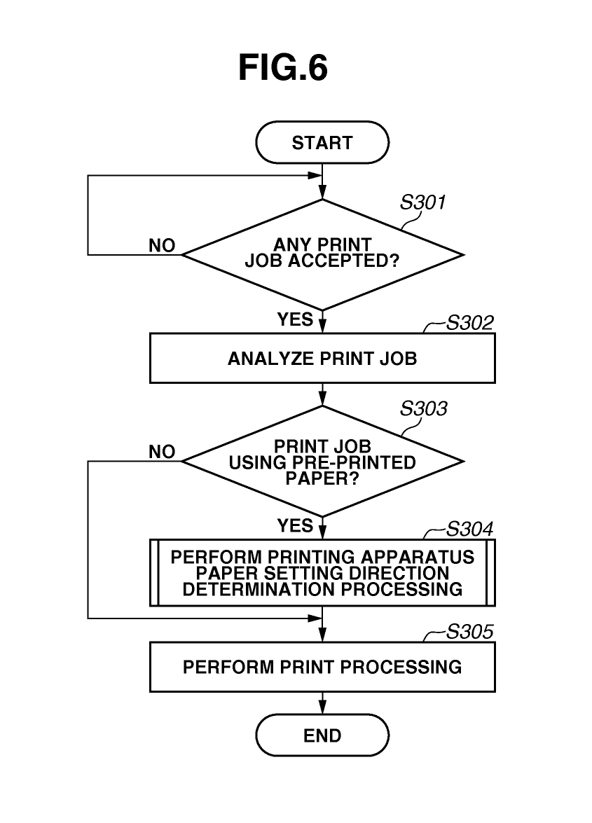

FIG. 6 is a flowchart illustrating a printing system control method according to the present exemplary embodiment. The flowchart illustrated in FIG. 6 is an example of the first paper setting direction determination processing that can be performed by the printing apparatus 111. To realize the processing in each step of the flowchart illustrated in FIG. 6, the CPU 115 executes a program loaded from the ROM 113 into the RAM 114.

In step S301, the control processing unit 214 accesses the communication unit 212 and determines whether there is any print job that has been received from the smart mobile 101. If it is confirmed that the communication unit 212 has received a print job, the control processing unit 214 stores the print job accepted from the smart mobile 101 in the memory unit 217.

Subsequently, in step S302, the control processing unit 214 acquires the print job from the memory unit 217 and instructs the print job analyzing unit 211 to analyze the print job. In this case, the print job analyzing unit 211 extracts information indicating whether the print job uses the pre-printed paper, as information to be used in printing, and stores the extracted information in the memory unit 217. Subsequently, the processing proceeds to step S303. In step S303, the control processing unit 214 accesses the memory unit 217 and determines whether the input print job uses a pre-printed paper. If the control processing unit 214 determines that the input print job does not use any pre-printed paper (NO in step S303), the processing proceeds to step S305.

In step S305, the control processing unit 214 acquires the print job from the memory unit 217, and instructs the printer engine 120 to perform printing of the print job. Then, the control processing unit 214 terminates the processing of the flowchart illustrated in FIG. 6. Processing to be performed in step S304 is described in detail below.

Next, as a second example, it is presumed that print data of a generated print job is comparable to one page of “A4” size. The printing system performs direct copy processing on a pre-printed paper of “A4” size based on the print job data, as described below.

### <Second Paper Setting Direction Determination Processing by Smart Mobile>

First, second paper setting direction determination processing that can be performed by the smart mobile is described in detail below with reference to the flowchart illustrated in FIG. 4A.

In step S601, if a user presses the print start button 903 illustrated in FIG. 5A, the control processing unit 209 instructs the display processing unit 202 to display the selection screen 904 on the touch panel 108. The selection screen 904 enables the user to instruct whether to use a pre-printed paper.

Subsequently, if the control processing unit 209 confirms that the user has pressed a YES button 905 on the selection screen 904, the control processing unit 209 accesses the memory unit 204 and writes information indicating that the print job uses the pre-printed paper. Then, the processing proceeds to step S602.

In step S602, the control processing unit 209 reads print information corresponding to the print content 902 from the memory unit 204, and instructs the print job generation unit 206 to generate a print job. Further, the control processing unit 209 instructs the memory unit 204 to read the information indicating that the print job uses the pre-printed paper, and instructs the communication unit 207 to transmit the generated print job together with the information about the usage of the pre-printed paper to the printing apparatus 111. Subsequently, in step S603, the control processing unit 209 accesses the memory unit 204 and determines whether the print job is a pre-printed paper using job. If the control processing unit 209 determines that the print job uses the pre-printed paper (YES in step S603), the processing proceeds to step S604.

Hereinafter, the processing to be performed in step S604 illustrated in FIG. 4A is described in detail below with reference to the flowchart illustrated in FIG. 4B.

In step S605 illustrated in FIG. 4B, the control processing unit 209 instructs the display processing unit 202 to display a pre-printed paper photographing mode screen 906 illustrated in FIG. 5B on the touch panel 108. Further, the control processing unit 209 instructs the imaging unit 205 to launch functions of the imaging device 110, and displays a video signal input from the imaging device 110 on the touch panel 108. Thus, a paper video image of the pre-printed paper obtained via the imaging device 110 can be displayed in an area 907 of the touch panel 108. Subsequently, the operation of the control processing unit 209 proceeds to step S606. If the user presses a guide display button 908 on the pre-printed paper photographing mode screen 906, the control processing unit 209 stores information indicating that the guide display flag is ON in the memory unit.

In step S606, the control processing unit 209 accesses the memory unit 204 and determines whether the guide display flag is ON. If the control processing unit 209 determines that the guide display flag is ON (YES in step S606), the processing proceeds to step S607. In step S607, the control processing unit 209 instructs the display processing unit 202 to display a photographing guide 911 (i.e., a rectangular area indicated by a dotted line in FIG. 5C) on the touch panel 108. Subsequently, the operation of the control processing unit 209 proceeds to step S608. Then, if the user presses a guide deletion button 912 on a pre-printed paper photographing mode screen 910 illustrated in FIG. 5C, the control processing unit 209 accesses the memory unit 204 and stores information indicating that the guide display flag is OFF.

Then, in step S608, the control processing unit 209 accesses the memory unit 204 and determines whether the guide display flag is OFF. If the control processing unit 209 determines that the guide display flag is OFF (YES in step S608), the processing proceeds to step S609.

In step S609, the control processing unit 209 instructs the display processing unit 202 to delete the photographing guide 911 from the touch panel 108. Subsequently, the processing proceeds to step S610. In step S610, the control processing unit 209 accesses the memory unit 204 and determines whether a photographing button 909 has been pressed. If the control processing unit 209 determines that the photographing button 909 has not been pressed by the user (NO in step S610), the processing returns to step S606.

It is now assumed that the user presses the guide display button 908 on the pre-printed paper photographing mode screen 906 illustrated in FIG. 5B. Further, if it is determined that the user presses the photographing button 909 without pressing the guide deletion button 912 on the pre-printed paper photographing mode screen 910 illustrated in FIG. 5C, the processing proceeds to step S606, step S607, step S608, and step S610. Processing to be performed in these steps is described in detail below. Here, the function of the photographing guide 911 is described in detail below.

The user can operate the photographing guide 911 to designate the paper size of the pre-printed paper while the printing system performs photographing processing. For example, if the paper size of the pre-printed paper designated by the user is “A4”, the user can press the photographing button 909 after adjusting the photographing distance between the smart mobile 101 and the pre-printed paper so that the pre-printed paper coincides with a dotted line frame of the photographing guide 911. In this state, if the control processing unit 209 determines that the user has pressed the photographing button 909 illustrated in FIG. 5C (YES in step S610), the processing proceeds to step S611.

In step S611, the control processing unit 209 instructs the imaging unit 205 to perform photographing processing, and stores image data of the photographed pre-printed paper in the memory unit 204. Subsequently, the processing proceeds to step S612. In step S612, the control processing unit 209 accesses the memory unit 204 and acquires the captured image data (i.e., the image data corresponding to the pre-printed sheet). Subsequently, the control processing unit 209 instructs the image analyzing unit 218 to extract a pre-printed image area from the photographed image data. Then, the control processing unit 209 stores the extracted image data in the memory unit 204, and the processing proceeds to step S613.

In step S613, the control processing unit 209 accesses the memory unit 204 and determines whether the photographing guide 911 has been displayed in the photographing processing in step S611. If the control processing unit 209 determines that the photographing guide 911 has been displayed in the photographing processing in step S611 (YES in step S613), the processing proceeds to step S614. In step S614, the control processing unit 209 accesses the memory unit 204 and acquires pre-printed image data.

Then, the control processing unit 209 instructs the image analyzing unit 218 to finalize the size of the pre-printed image. In this case, the image analyzing unit 218 determines that the size of the pre-printed paper is “A4” because the pre-printed paper has been captured along the photographing guide 911. The control processing unit 209 stores size information about the finalized pre-printed paper in the memory unit 204. Subsequently, the processing proceeds to step S615. Hereinafter, pre-printed paper setting parameter finalization processing (i.e., processing to be performed in step S615 and subsequent steps in FIG. 4A) that can be performed by the control processing unit 209 is described in detail below with reference to the flowcharts illustrated in FIGS. 4C-A and 4C-B.

In step S616 illustrated in FIGS. 4C-A, the control processing unit 209 of the smart mobile 101 instructs the display processing unit 202 to display a paper set mode screen 914 illustrated in FIG. 5D on the touch panel 108. Subsequently, the processing proceeds to step S617. Hereinafter, the paper set mode screen 914 illustrated in FIG. 5D is described in detail below.

The paper set mode screen 914 includes a pre-printed image 915 that has been extracted by the image analyzing unit 218. Further, the paper set mode screen 914 includes two indices 916 and 917 that can identify the setting direction of the pre-printed paper displayed by the pre-printed image 915 in any one of the cassettes included in the paper feeding device unit 119. The indices 916 and 917 indicate that the top of the pre-printed image 915 faces the device back side and the pre-printed paper faces the ceiling side.

A paper size button 918 is operable to designate the paper size of the pre-printed paper (more specifically, one of “A4”, “A3”, “LTR”, and “11×17” in the present exemplary embodiment). A paper feeding device button 923 is operable to designate a paper feeding device that feeds the pre-printed paper.

If the control processing unit 209 determines that the user has pressed the paper feeding device button 923 on the paper set mode screen 914 (YES in step S617), the processing proceeds to step S618. In step S618, the control processing unit 209 instructs the display processing unit 202 to perform a pop-up display 924 that enables the user to select a desired paper feeding device on the touch panel 108.

If the user presses a paper feeding device number “1” button 925, the control processing unit 209 stores information about the pressed paper feeding device number “1” in the memory unit 204. Subsequently, the processing proceeds to step S619. Further, if the control processing unit 209 determines that the user has pressed the paper size button 918 (YES in step S619), the processing proceeds to step S620.

In step S620, the control processing unit 209 instructs the display processing unit 202 to perform a pop-up display 919 that enables the user to select a desirable paper size on the touch panel 108. If the user presses a paper size “A4” button 928 on the pop-up display 919, the control processing unit 209 stores information about the pressed paper size “A4” in the memory unit 204. For example, if paper size information is stored in the memory unit 204 through the processing in step S614 illustrated in FIG. 4B, the control processing unit 209 overwrites the data stored in the memory unit 204 with the paper size information designated in step S620. After the control processing unit 209 completes the storage of the paper size information in the memory unit 204, the processing proceeds to step S621.

A method for designating a paper setting direction of a pre-printed paper, which can be performed by a user who operates the smart mobile 101, is described.

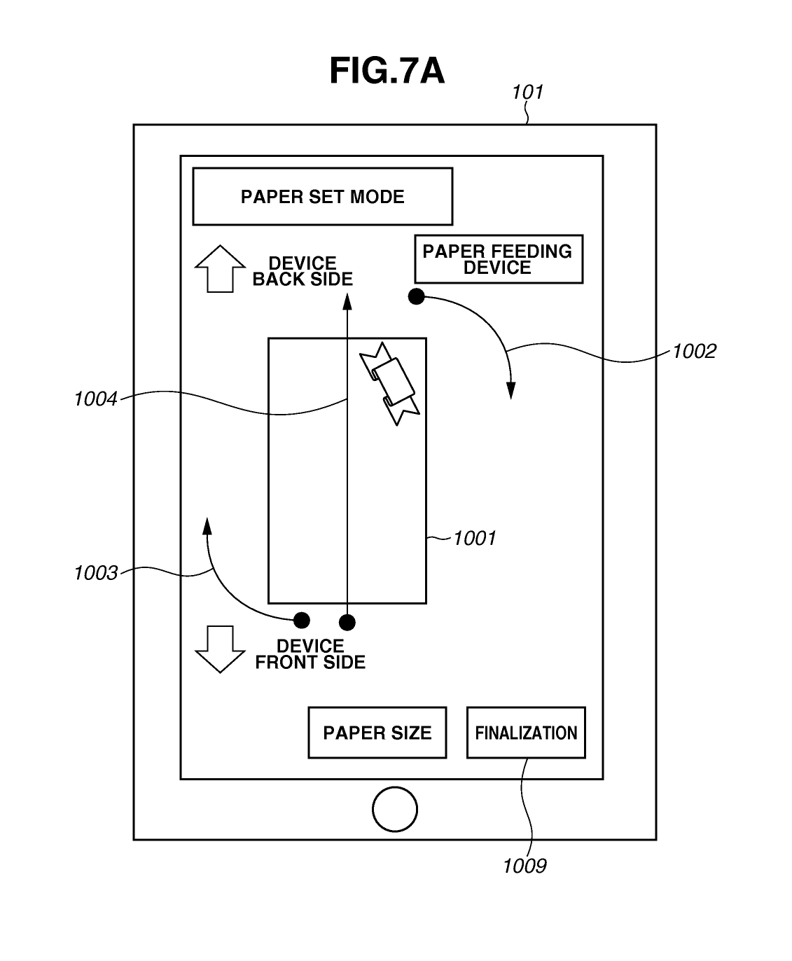

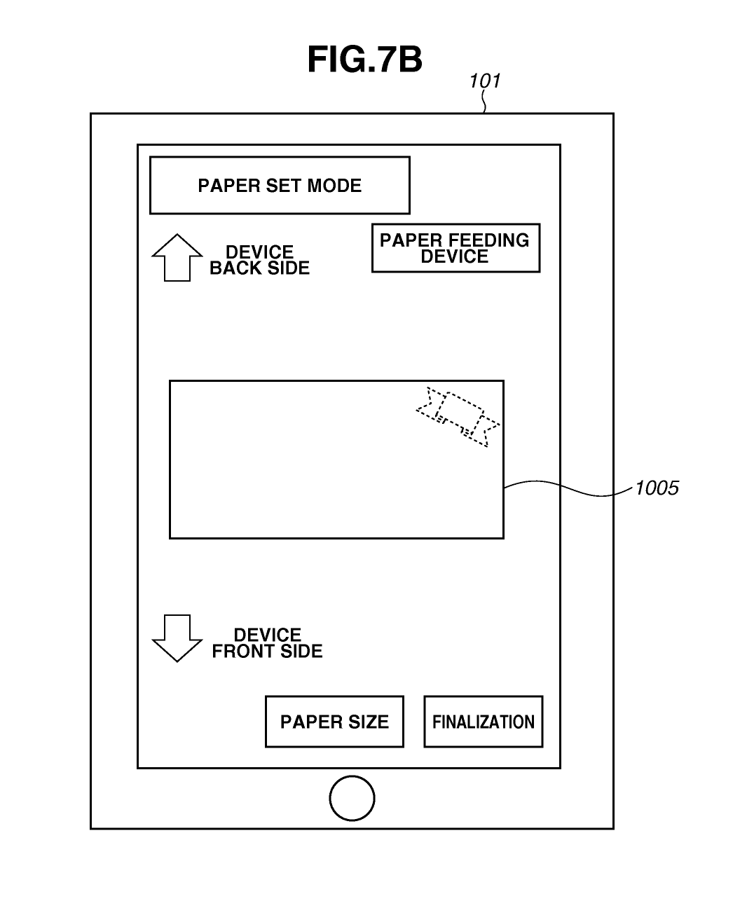

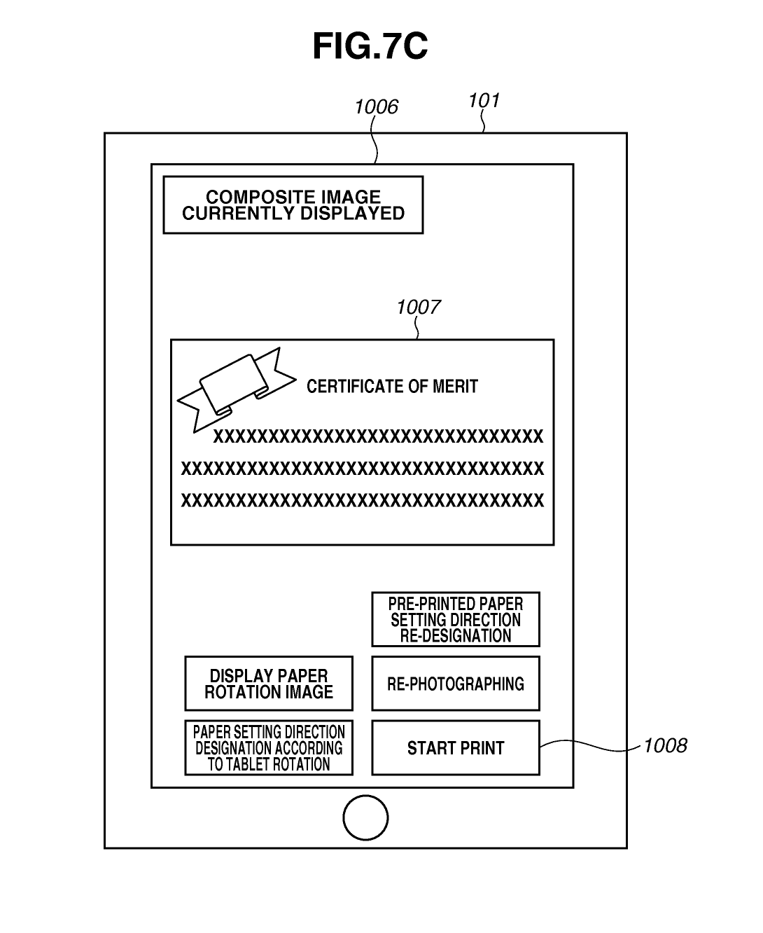

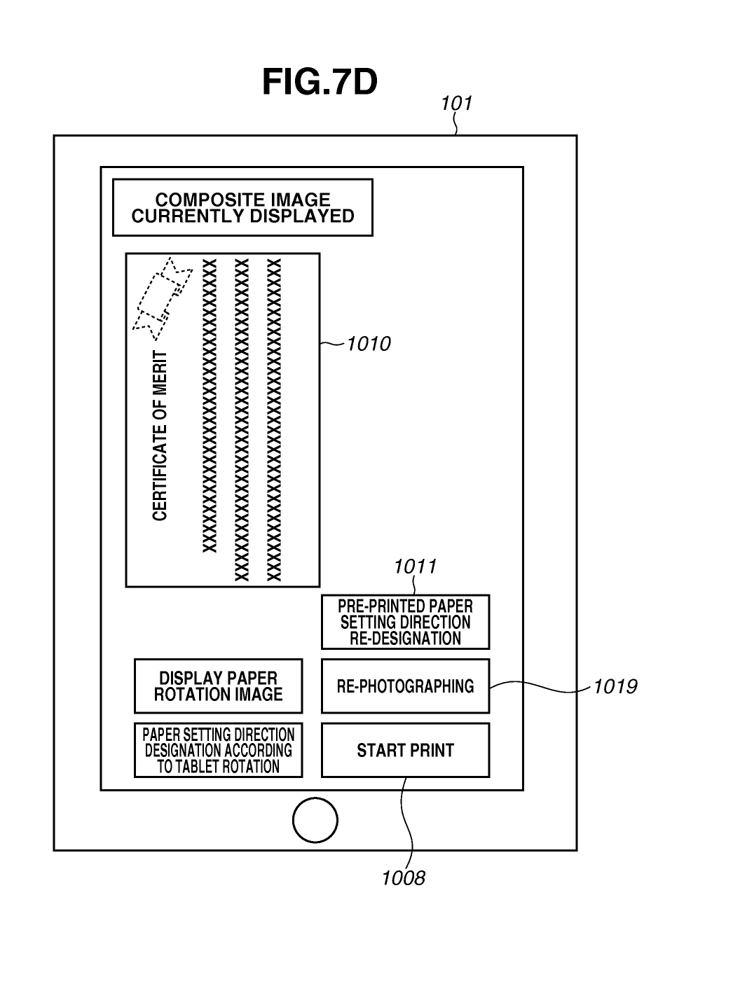

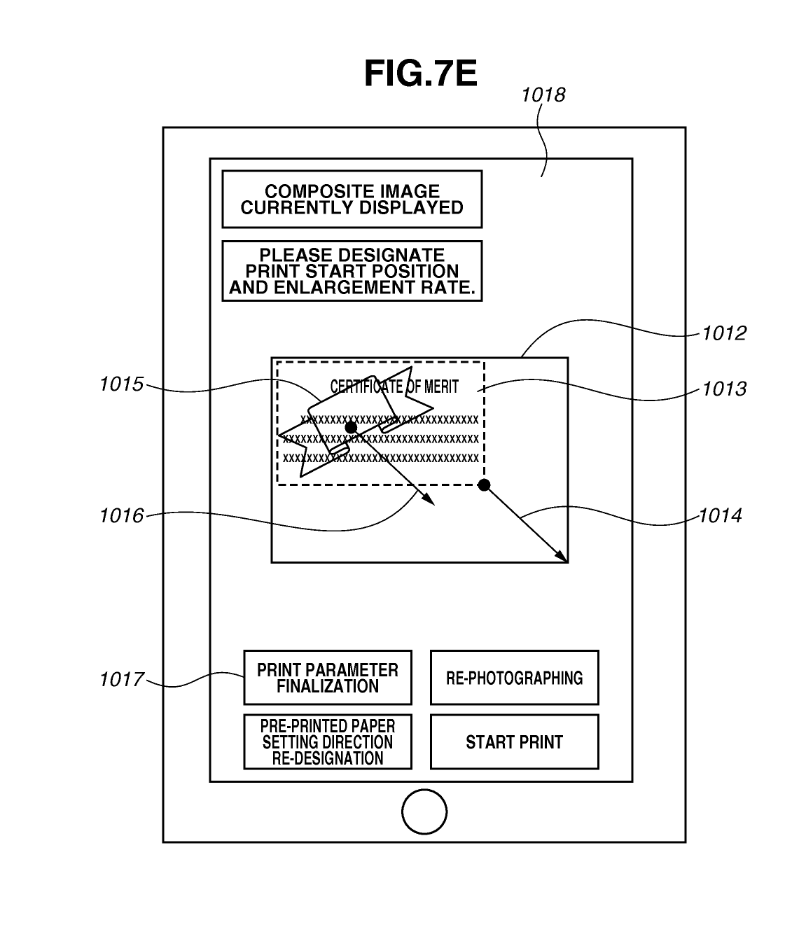

A user instructs a desired paper setting direction by operating the pre-printed image 915 displayed on the touch panel 108 with the tip of a finger. For example, when the user slides a forefinger and a thumb along an arrow 926 and an arrow 927 on the touch panel 108, the pre-printed image 915 rotates in a direction indicated by an arrow 1002 in FIG. 7A. The above-mentioned user operation indicates that the pre-printed paper is oriented in the Long Edge Feed (LEF) direction, and is set to face the ceiling side in any one of the cassettes included in the paper feeding device unit 119. In the present exemplary embodiment, the paper setting direction is expressed using LEF/SEF. FIGS. 7A to 7E illustrate screen display examples in association with the display control of composite image data displayed on the touch panel 108.

In the present exemplary embodiment, “LEF” stands for Long Edge Feed, which indicates setting a paper in such a manner that the long side of the paper is positioned vertically to the paper conveyance direction. Further, “SEF” stands for Short Edge Feed, which indicates setting a paper in such a manner that the short side of the paper is positioned vertically to the paper conveyance direction. Further, the direction of a print surface of the pre-printed paper is expressed using ceiling side/ground side. If a user operates the touch panel 108 to slide a pre-printed image 1001 illustrated in FIG. 7A in the directions indicated by the arrows 1002 and 1003, a pre-printed image 1004 further rotates 90° in the right direction.

Subsequently, if the user further operates the touch panel 108 to cause a slide movement toward the pre-printed image 1001, the pre-printed image is switched to a reversed image of the pre-printed image on the touch panel 108. A pre-printed image 1005 illustrated in FIG. 7B can be obtained by rotating the pre-printed image 915 illustrated in FIG. 5D by 90° in the right direction and further reversing the paper along a line extending from a device front side to a device back side. As mentioned above, when a user performs a screen operation on the smart mobile 101, the user can intuitively instruct the paper setting direction of each pre-printed paper in any one of the cassettes included in the paper feeding device unit 119 provided in the printing apparatus 111.

If the user operates the touch panel 108 to change the pre-printed image 915 into the state illustrated in FIG. 7B (see the pre-printed image 1005), the control processing unit 209 performs a control in the following manner. More specifically, the control processing unit 209 instructs the display processing unit 202 to read direction information about the pre-printed paper in any one of the cassettes included in the paper feeding device unit 119 and to store the acquired direction information in the memory unit 204. In the present exemplary embodiment, the control processing unit 209 accesses the memory unit 204, and stores information indicating that the direction of the pre-printed paper with respect to the selected cassette of the paper feeding device unit 119 is “SEF” and the print surface of the pre-printed paper is directed to the ground side.

Subsequently, the operation of the control processing unit 209 proceeds to step S622 illustrated in FIGS. 4C-A. If the user operates the touch panel 108 to press a finalization button 920 illustrated in FIG. 5D, the processing proceeds to step S623. In step S623, the control processing unit 209 reads information about the paper setting direction, the pre-printed image, the paper feeding device number, and the paper size from the memory unit 204, and instructs the communication unit 207 to transmit the read information to the printing apparatus 111.

Subsequently, the operation of the control processing unit 209 proceeds to step S624 illustrated in FIG. 4A. Hereinafter, processing that can be performed by the printing apparatus 111 for combining the pre-printed image with a print job image based on the paper setting direction is described in detail below.

In step S624, the control processing unit 209 accesses the memory unit 204, and determines whether composite image data has been received from the printing apparatus 111. If the control processing unit 209 determines that the composite image data has been received (YES in step S624), the processing proceeds to step S625. In step S625, the control processing unit 209 reads the composite image data from the memory unit 204, and instructs the display processing unit 202 to display composite image data 1007 on the touch panel 108, as a composite image (i.e., an image obtained through image processing) on a screen 1006 illustrated in FIG. 7C. In the present exemplary embodiment, the composite image is a preview image that corresponds to a print result that can be obtained when the print data generated from the print job is printed on the pre-printed paper.

More specifically, the composite image data 1007 corresponds to image data that can be obtained by combining the pre-printed image data generated by the printing apparatus 111 with the print job image data. In other words, the composite image data 1007 indicates that the print job can be printed as a printed product when a printing operation is performed with the pre-printed paper by the setting of the direction having been designated beforehand by the user. If the printed product is satisfactory for the user, the user presses a print start button 1008 illustrated in FIG. 7C.

After the control processing unit 209 completes the above-mentioned composite image display processing, the processing proceeds to step S626. In step S626, the control processing unit 209 accesses the memory unit 204 and determines whether a print position and enlargement rate designation UI display instruction has been received from the printing apparatus 111. The printing apparatus 111 can generate the UI display instruction when an image size of the input print job is different from the paper size of the pre-printed paper. The above-mentioned processing is described in detail below.

If the control processing unit 209 determines that the print position and enlargement rate designation UI display instruction has not been received from the printing apparatus 111 (NO in step S626), the processing proceeds to step S627 illustrated in FIG. 4A. In the present exemplary embodiment, if the control processing unit 209 determines that the user has pressed the print start button 1008 illustrated in FIG. 7C (YES in step S627), the processing proceeds to step S628. In step S628, the control processing unit 209 instructs the communication unit 207 to transmit a print start command to the printing apparatus 111, and terminates the processing of the flowchart illustrated in FIG. 4A. In this case, it is assumed that the user stores the pre-printed paper in a selected cassette of the paper feeding device unit 119 in such a way as to correspond to the pre-printed image displayed on the smart mobile 101.

### <Second Paper Setting Direction Determination Processing by Printing Apparatus>

Subsequently, second paper setting direction determination processing that can be performed by the printing apparatus 111 is described in detail below with reference to the flowchart illustrated in FIG. 6. To realize the processing of the flowchart illustrated in FIG. 6, the CPU 115 executes a program loaded from the ROM 113 into the RAM 114.

In step S301, the control processing unit 214 accesses the memory unit 217, and confirms whether a print job has been received. If the control processing unit 214 determines that the print job has been received (YES in step S301), the processing proceeds to step S302, and step S303 although redundant description thereof will be avoided. If the control processing unit 214 determines that the input print job is a pre-printed paper using print job (YES in step S303), the processing proceeds to step S304.

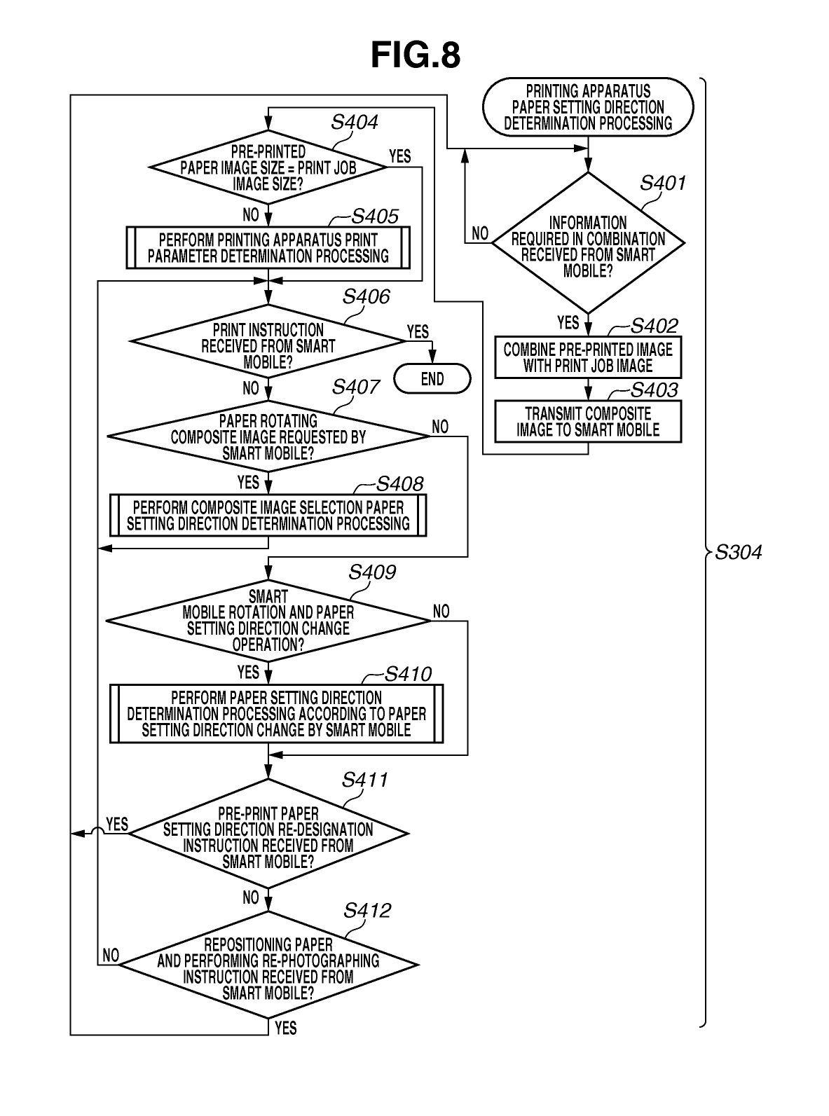

The processing in step S304 to be performed by the printing apparatus 111 is described in detail below with reference to a flowchart illustrated in FIG. 8.

FIG. 8 is a flowchart illustrating a printing system control method according to the present exemplary embodiment. To realize the processing in each step, the CPU 115 executes a program loaded from the ROM 113 into the RAM 114 in the printing apparatus 111.

In step S401, the control processing unit 214 of the printing apparatus 111 accesses the memory unit 217, and determines whether information required to combine a pre-printed paper image with a print job image has been received from the smart mobile 101. The information required in the image composition is the pre-printed image, the paper setting direction, the paper size, and the paper feeding device number.

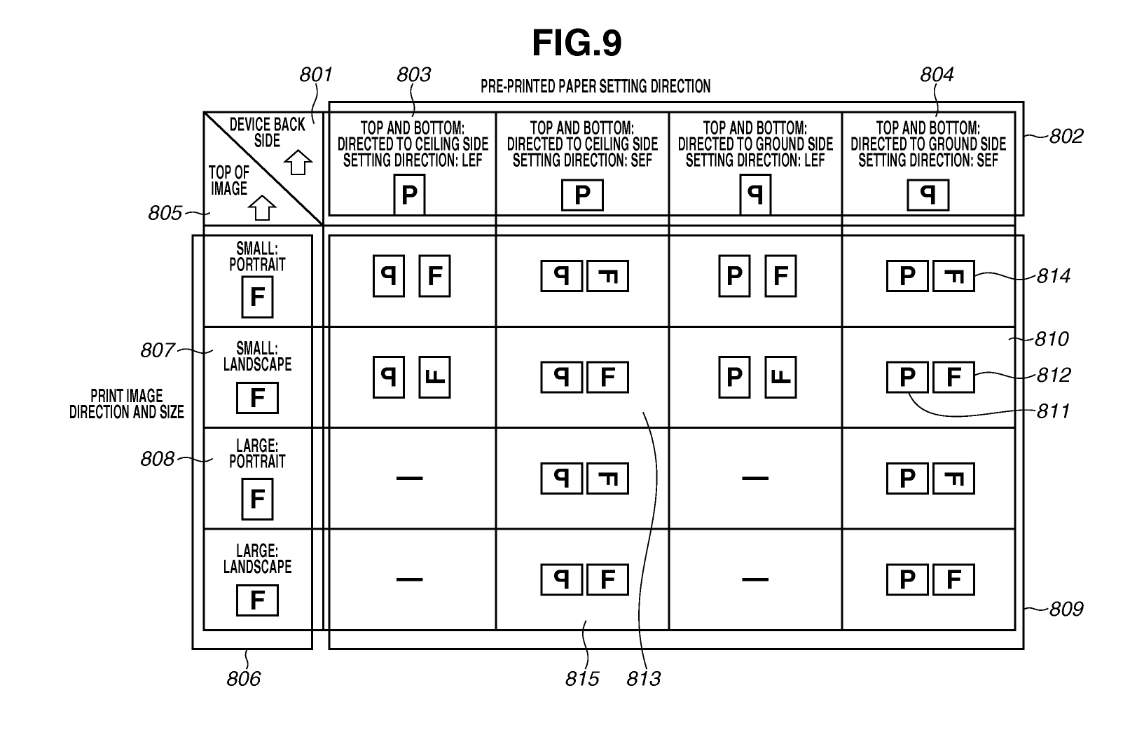

If the control processing unit 214 determines that the information required to combine the pre-printed paper image with the print job image has been received (YES in step S401), the processing proceeds to step S402. In step S402, the control processing unit 214 instructs the preview image combining unit 213 to generate an image corresponding to a print result that can be obtained by combining the pre-printed paper image with the print job image based on the pre-printed image, the paper setting direction, the paper size, and the paper feeding device number. A composite image generation method is described in detail below with reference to FIG. 9. An image corresponding to the print result can be previewed on the touch panel 108 as described below.

FIG. 9 illustrates a database DB relating to combinations of the pre-printed paper setting direction and the print direction, in a paper feeding device 1 included in the printing apparatus 111 illustrated in FIG. 1.

The database DB illustrated in FIG. 9 indicates how a print job is printed in relation to the pre-printed paper setting direction in any one of the paper feeding cassettes provided in the paper feeding device unit 119. In FIG. 9, a rectangular image suffixed with “P” indicates an image to be printed on the pre-printed paper.

A portion surrounded by a frame 802 indicates a paper setting direction with respect to a device back side 801. For example, a setting direction 803 indicates that the print surface of the pre-printed paper is directed to the ceiling side and the paper setting direction is “LEF” in a state where the pre-printed paper is set in any one of the cassettes included in the paper feeding device unit 119.

Further, a setting direction 804 indicates that the print surface of the pre-printed paper is directed to the ground side and the paper setting direction is “SEF” in a state where the pre-printed paper is set in the paper feeding device. Further, the rectangular image suffixed with “F” indicates the print job. Further, a portion surrounded by a frame 806 indicates an image size of the print job and indicates whether the print job image is portrait or landscape. For example, a landscape 807 indicates that the print job image belongs to “Small group” (e.g., “A4” or “B5”) in size and the layout thereof is landscape.

Further, a portrait 808 indicates that the print job image belongs to “Large group” (e.g., “11×17”) in size and the layout thereof is portrait. A portion surrounded by a frame 809 indicates a print direction of each printed print job image with respect to the pre-printed paper setting direction. For example, it is now presumed that the pre-printed paper is set in the setting direction 804 and the print job is the landscape 807 (i.e., Small group) with respect to the print image direction and the size.

An image 811 of a combination 810 indicates that the pre-printed paper is reversed upside down when it is fed, and a print job F image 812 is printed on the reversed pre-printed paper. The control processing unit 214 accesses the memory unit 217, and identifies the pre-printed paper setting direction and the print direction in the database DB with reference to the paper feeding device number. Further, the control processing unit 214 identifies necessary image composition rules in the combination 809 with reference to the paper setting direction and the paper size designated by the smart mobile 101 based on the identified information obtained from the DB.

In the present exemplary embodiment, the paper feeding device number of the print job received from the smart mobile 101 is “1”. Therefore, the database DB illustrated in FIG. 9 can be used in the preview image combination. Further, the print job image has the “A4” size and the layout thereof is landscape. Therefore, the information to be referred to in the preview image combination is the print image direction and the size of the line 807. Further, the paper setting direction designated by the smart mobile 101 is the ground side and the SEF direction. Therefore, the information to be used in the image combination is the setting direction field 810. The control processing unit 214 causes the preview image combining unit 213 to generate a composite image with reference to the identified image composition rules.

The pre-printed image transmitted from the smart mobile 101 in this case corresponds to the pre-printed image in the area 907 illustrated in FIG. 5B. In this case, the pre-printed image is designated to be set in a state where the pre-printed image is rotated 180° in the right direction by a user operation and is further turned upside down along the device backward direction, i.e., the state of the pre-printed image 1005 illustrated in FIG. 7B.

The control processing unit 214 instructs the preview image combining unit 213 to generate a composite image by reversing the input pre-printed image 1005 from the image 804 to the image 811 in the database DB illustrated in FIG. 9 and superposing the print job image 812 on the reversed image. The composite image obtained in this case is the composite image data 1007. If the control processing unit 214 completes the above-mentioned generation of the composite image data, the control processing unit 214 stores the generated composite image data in the memory unit 217. Then, the processing proceeds to step S403 illustrated in FIG. 8.

In step S403 illustrated in FIG. 8, the control processing unit 214 acquires the composite image data from the memory unit 217, and instructs the communication unit 212 to transmit the acquired composite image data to the smart mobile 101. Subsequently, the processing proceeds to step S404. In step S404, the control processing unit 214 accesses the memory unit 217, and determines whether the image size of the accepted print job coincides with the paper size of the pre-printed paper. If the control processing unit 214 determines that the print job image size coincides with the pre-printed paper size (YES in step S404), the processing proceeds to step S406.

In step S406, the control processing unit 214 accesses the memory unit 204, and determines whether a print command has been received from the smart mobile 101. If the control processing unit 214 determines that the print command has been received from the smart mobile 101 (YES in step S406), the processing proceeds to step S305 illustrated in FIG. 6.

In step S305 illustrated in FIG. 6, the control processing unit 214 acquires the print job from the memory unit 217, and instructs the printer engine 120 to perform printing. Then, the control processing unit 214 terminates the processing of the flowchart illustrated in FIG. 6.

Next, as a third example, it is presumed that print data of a generated print job is comparable to one page of “A4” size. The printing system performs printing on a pre-printed paper of “A4” size based on the print job data. In this case, the processing that can be performed by the printing system includes re-designating the setting direction of the pre-printed paper if an obtained composite image does not satisfy user's intent. Further, the processing that can be performed by the printing system includes re-photographing the pre-printed paper if an obtained composite image does not satisfy user's intent, as described below.

### <Third Paper Setting Direction Determination Processing by Smart Mobile>

First, third paper setting direction determination processing that can be performed by a smart mobile is described. To realize the processing of the flowchart, the CPU 104 executes a program loaded from the ROM 102 into the RAM 103.

In step S601 illustrated in FIG. 4A, if a user who operates the smart mobile 101 presses the print start button 903 displayed on the touch panel 108, the control processing unit 209 performs a control in the following manner. The control processing unit 209 instructs the display processing unit 202 to display the selection screen 904 illustrated in FIG. 5A on the touch panel 108. Subsequently, if the user presses the YES button 905, the control processing unit 209 accesses the memory unit 204 and writes information indicating that the print job uses the pre-printed paper. Then, the processing proceeds to step S602. Hereinafter, if an operation performed by the user is similar to that described in the second example, the processing proceeds from step S602 to step S603 to step S621 successively illustrated in FIG. 4A and FIGS. 4C-A, although redundant description thereof will be avoided.

The user operates the touch panel 108 to change the direction of the pre-printed image in such a way as to coincide with the directions indicated by the arrows 1002 and 1003 illustrated in FIG. 7A. Through the above-mentioned operation, the control processing unit 209 accesses the memory unit 204, and stores information indicating that the paper setting direction of the pre-printed paper in the paper feeding device 1 is “LEF” and the print surface of the pre-printed paper is directed to the ceiling side.

Subsequently, the operation of the control processing unit 209 proceeds to step S622 illustrated in FIGS. 4C-A. If the user operates the touch panel 108 of the smart mobile 101 to press a finalization button 1009, the processing proceeds to step S623. In step S623, the control processing unit 209 reads information about the paper setting direction, the pre-printed image, the paper feeding device number, and the paper size from the memory unit 204, and instructs the communication unit 207 to transmit the read information to the printing apparatus 111. Subsequently, the operation of the control processing unit 209 proceeds to step S624 illustrated in FIG. 4A. In step S624, the control processing unit 209 accesses the memory unit 204, and determines whether composite image data has been received from the printing apparatus 111. If the control processing unit 209 determines that the composite image data has been received from the printing apparatus 111 (YES in step S624), the processing proceeds to step S625. In step S625, the control processing unit 209 reads the composite image data from the memory unit 204 and instructs the display processing unit 202 to display composite image data 1010 on the touch panel 108 as illustrated in FIG. 7D.

Subsequently, the operation of the control processing unit 209 successively proceeds to step S626 and step S627 although redundant description of the processing will be avoided. In the present exemplary embodiment, the composite image data 1010 indicates that the print surface of the pre-printed paper faces the ground side and a print job image is combined with a non-printed surface of the pre-printed paper. A preview image obtained in this case does not indicate a printed product required by the user. Therefore, the user can intuitively confirm that the instructed pre-printed paper setting method leads to an unintended print result, on the display screen of the smart mobile 101.

In the screen illustrated in FIG. 7D, if the user presses a button 1011 to re-designate the pre-printed paper setting direction, the control processing unit 209 causes the memory unit 204 to store the pre-printed paper setting direction re-designation instruction. In step S627, the control processing unit 209 accesses the memory unit 204, and confirms whether the print start button 1008 has been pressed. If the control processing unit 209 determines that the print start button 1008 has not been pressed (NO in step S627), the processing proceeds to step S629. In step S629, the control processing unit 209 accesses the memory unit 204, and determines whether a paper rotating composite image has been required. The paper rotating composite image is described in detail below. If the control processing unit 209 determines that the paper rotating composite image has not been required (NO in step S629), the processing proceeds to step S630.

In step S630, the control processing unit 209 accesses the memory unit 204, and determines whether changing the paper setting direction according to the rotation of the smart mobile 101 has been instructed. The paper setting direction change processing according to the rotation of the smart mobile 101 is described in detail below. If the control processing unit 209 determines that changing the paper setting direction according to the rotation of the smart mobile 101 has not been instructed (NO in step S630), the processing proceeds to step S631.

In step S631, the control processing unit 209 accesses the memory unit 204, and determines whether re-designating the pre-printed paper setting direction has been instructed. If the control processing unit 209 determines that re-designating the pre-printed paper setting direction has been instructed (YES in step S631), the processing proceeds to step S633. In step S633, the control processing unit 209 instructs the communication unit 212 to notify the printing apparatus 111 of the re-designation of the pre-printed paper setting direction.

Subsequently, the processing proceeds to step S615. Subsequently, the user can re-designate the paper setting direction of the pre-printed paper by operating the touch panel 108. The designation of the pre-printed paper setting direction has been already described, and therefore redundant description thereof will be avoided.

On the other hand, if the control processing unit 209 determines that re-designating the pre-printed paper setting direction has not been instructed (NO in step S631), the processing proceeds to step S632. If the user presses a re-photographing button 1019 on the screen illustrated in FIG. 7D, the control processing unit 209 accesses the memory unit 204, and stores information indicating that the re-photographing button 1019 has been pressed.

Next, in step S632, the control processing unit 209 accesses the memory unit 204, and determines whether the re-photographing button 1019 has been pressed. If the control processing unit 209 determines that the re-photographing button 1019 has not been pressed (NO in step S632), the processing proceeds to step S627.

On the other hand, if the control processing unit 209 determines that the re-photographing button 1019 has been pressed (YES in step S632), the processing proceeds to step S643. In step S643, the control processing unit 209 instructs the communication unit 207 to notify the printing apparatus 111 of resetting and re-photographing the paper.

Subsequently, the processing proceeds to step S604. The following processing has been already described and therefore the redundant description thereof will be avoided.

### <Third Paper Setting Direction Determination Processing by Printing Apparatus>

Subsequently, third paper setting direction determination processing that can be performed by the printing apparatus 1111 is described below. To realize the processing of the flowchart, the CPU 115 executes a program loaded from the ROM 113 into the RAM 114.

In step S301 illustrated in FIG. 6, the control processing unit 214 accesses the communication unit 212, and determines whether a print job has been accepted. If the control processing unit 214 determines that the communication unit 212 has accepted the print job (YES in step S301), the processing proceeds to step S302, step S303, and step S304 illustrated in FIG. 6 and to step S401, step S402, step S403, step S404, and step S406 illustrated in FIG. 8.

The processing to be performed in the above-mentioned steps has been already described, and therefore redundant description thereof will be avoided.

Then, in step S406 illustrated in FIG. 8, the control processing unit 214 of the printing apparatus 111 accesses the memory unit 217, and determines whether a print instruction has been received from the smart mobile 101. If the control processing unit 214 determines that there is not any print instruction received from the smart mobile 101 (NO in step S406), the processing proceeds to step S407. In step S407, the control processing unit 214 accesses the memory unit 217, and determines whether a paper rotating composite image has been requested by the smart mobile 101. The processing to be performed when the paper rotating composite image is requested by the smart mobile 101 is described in detail below.

In the present exemplary embodiment, if the control processing unit 214 determines that the paper rotating composite image has not been requested by the smart mobile 101 (NO in step S407), the processing proceeds to step S409. In step S409, the control processing unit 214 accesses the memory unit 217, and determines whether finalizing the paper setting direction according to the rotation of the smart mobile 101 has been instructed. The paper setting direction finalization processing according to the rotation of the smart mobile 101 is described below.

If the control processing unit 214 determines that finalizing the paper setting direction according to the rotation of the smart mobile 101 has not been instructed (NO in step S409), the processing proceeds to step S411.

In step S411, the control processing unit 214 accesses the memory unit 217, and determines whether the pre-printed paper setting direction re-designation instruction has been received from the smart mobile 101. As described in the third paper setting direction determination processing that can be performed by the smart mobile 101, if the control processing unit 214 determines that the pre-printed paper setting direction re-designation instruction has been received from the smart mobile 101, the control processing unit 214 accesses the memory unit 217, and stores information indicating that the pre-printed paper setting direction re-designation instruction has been received. If the control processing unit 214 confirms that the pre-printed paper setting direction re-designation instruction has been received from the memory unit 217 (YES in step S411), the processing proceeds to step S401.

Subsequently, the information required in the image composition has been acquired from the smart mobile 101, and the control processing unit 214 generates preview image data (i.e., composite image data) based on the acquired information. The generation of the preview image data has been already described, and therefore redundant description thereof will be avoided.

Referring back to the processing to be performed in step S411, the control processing unit 214 accesses the memory unit 217. If the control processing unit 214 determines that the pre-printed paper setting direction re-designation instruction has not been received from the smart mobile 101 (NO in step S411), the processing proceeds to step S412. If the control processing unit 214 accepts a re-photographing instruction from the smart mobile 101, the control processing unit 214 accesses the memory unit 217, and stores information indicating that the re-photographing instruction has been accepted.

In step S412, the control processing unit 214 accesses the memory unit 217, and determines whether the re-photographing instruction has been accepted. If the control processing unit 214 determines that the re-photographing instruction has not been accepted (NO in step S412), the processing proceeds to step S406.

On the other hand, if the control processing unit 214 determines that the re-photographing instruction has been accepted (YES in step S412), the processing proceeds to step S401. The following processing has been already described, and therefore the redundant description thereof will be avoided.

Further, as a fourth example, it is presumed that print data of a generated print job is comparable to one page of “A4” size. The printing system performs enlargement printing on a pre-printed paper of “A3” size based on the print job data.

### <Fourth Paper Setting Direction Determination Processing by Smart Mobile>

First, fourth paper setting direction determination processing that can be performed by the smart mobile 101 is described below. To realize the processing of the flowchart, the CPU 104 executes a program loaded from the ROM 102 into the RAM 103.

In step S601 illustrated in FIG. 4A, if a user presses the print start button 903 (see FIG. 5A) displayed on the touch panel 108 of the smart mobile 101, the control processing unit 209 performs a control in the following manner. The control processing unit 209 instructs the display processing unit 202 to display the selection screen 904 illustrated in FIG. 5A on the touch panel 108. Subsequently, if the user presses the YES button 905, the control processing unit 209 accesses the memory unit 204, and writes information indicating that the print job uses the pre-printed paper. Then, the processing proceeds to step S602. Hereinafter, if an operation performed by the user is similar to that described in the third paper setting direction determination processing performed by the smart mobile 101, the processing proceeds to step S602 to step S619 illustrated in FIG. 4A and FIGS. 4C-A, although redundant description thereof will be avoided.

If the user presses the paper size button 918 in a state where the paper set mode screen 914 illustrated in FIG. 5D is displayed on the touch panel 108, the operation of the control processing unit 209 proceeds to step S620 illustrated in FIGS. 4C-A.

In step S620, the control processing unit 209 instructs the display processing unit 202 to perform the pop up display 919 that enables the user to select a desirable paper size on the touch panel 108. If the user presses a paper size “A3” button 921, the control processing unit 209 stores information about the pressed paper size “A3” in the memory unit 204. Subsequently, the operation of the control processing unit 209 proceeds to step S621.

Subsequently, the processing proceeds to step S621 and step S622. If the user presses the finalization button 920, the processing proceeds to step S622 and step S623 illustrated in FIGS. 4C-A and step S625 illustrated in FIG. 4A. The processing of the above-mentioned steps has been already described and therefore redundant description thereof will be avoided.

Then, in step S625 illustrated in FIG. 4A, the control processing unit 209 reads the composite image data from the memory unit 204. Then, the control processing unit 209 instructs the display processing unit 202 to display a screen 1018 illustrated in FIG. 7E on the touch panel 108 based on the composite image data in such a way as to accept an image information zooming instruction.

The screen 1018 illustrated in FIG. 7E includes composite image data 1012 that can be obtained based on the pre-printed image data generated by the printing apparatus 111 and the print job image data. In this case, the image size of the print job image is “A4” and the paper size of the pre-printed paper is “A3”.

Image composition rules applicable to the present exemplary embodiment, in which the image composition targets (i.e., the print job image data and the pre-printed paper) are mutually different in size, are described in detail below.

Further, when the image composition targets (i.e., the print job image data and the pre-printed paper) are mutually different in size, the printing apparatus 111 generates the print position and enlargement rate designation UI display instruction. If the smart mobile 101 accepts the above-mentioned instruction, the control processing unit 209 accesses the memory unit 204, and stores information indicating that the UI display instruction has been accepted.

Then, in step S625 illustrated in FIG. 4A, the control processing unit 209 causes the touch panel 108 to display the composite image data. Then, the processing proceeds to step S626. In step S626, the control processing unit 209 accesses the memory unit 204, and confirms whether displaying the print position and enlargement rate designation UI has been instructed. If the control processing unit 209 determines that displaying the print position and enlargement rate designation UI has been instructed (YES in step S626), the processing proceeds to step S634. Hereinafter, the processing to be performed in step S634 is described in detail below with reference to a flowchart illustrated in FIG. 4C-B.

In step S635 illustrated in FIG. 4C-B, the control processing unit 209 instructs the display processing unit 202 to display the screen 1018 illustrated in FIG. 7E. Subsequently, the processing proceeds to step S636. The screen 1018 illustrated in FIG. 7E includes the pre-printed image 1012 and a print job image 1015.

In the screen illustrated in FIG. 7E, the user can change the print position of the print job by operating the touch panel 108, and can change the size of the print job image 1015 to be printed in the print job.

For example, if the user operates the touch panel 108 in such a way as to slide a finger in the direction indicated by an arrow 1016, the print job image 1015 moves its position relative to a pre-printed image 1013 along the arrow 1016 while maintaining the image size thereof. Further, if the user touches an edge portion of the print job image displayed on the touch panel 108 and slides the finger in the direction indicated by an arrow 1014, the print job image 1015 enlarges the size thereof along the arrow 1014.

After the above-mentioned user operation has been completed, the control processing unit 209 instructs the display processing unit 202 to store the print parameters updated by the user operation in the memory unit 204.

Subsequently, the operation of the control processing unit 209 proceeds to step S637. If the user presses a print parameter finalization button 1017 illustrated in FIG. 7E, the control processing unit 209 instructs the display processing unit 202 to access the memory unit 204 to store information indicating that the print parameter finalization button 1017 has been pressed. In step S637, the control processing unit 209 accesses the memory unit 204, and determines whether the print parameter finalization button 1017 has been pressed. If the control processing unit 209 determines that the print parameter finalization button 1017 has been pressed (YES in step S637), the processing proceeds to step S638.

In step S638, the control processing unit 209 acquires the print parameters from the memory unit 204, and instructs the communication unit 207 to transmit the acquired print parameters to the printing apparatus 111. Subsequently, the processing proceeds to step S639. In step S639, the control processing unit 209 accesses the memory unit 204, and determines whether the composite image data has been accepted from the printing apparatus 111. If the control processing unit 209 determines that the composite image data has been accepted from the printing apparatus 111 (YES in step S639), the processing proceeds to step S640. In step S640, the control processing unit 209 acquires the composite image data from the memory unit 204, and instructs the display processing unit 202 to display a composite image (i.e., an image obtainable by combining the pre-printed paper image with the print job image based on the composite image data) on the touch panel 108. Subsequently, the control processing unit 209 terminates the processing of the flowchart illustrated in FIG. 4C-B. Subsequently, the processing proceeds to step S627 illustrated in FIG. 4A. If the user presses the print start button 903, the printing apparatus 111 starts a printing operation although redundant description thereof will be avoided.

### <Fourth Paper Setting Direction Determination Processing by Printing Apparatus>

Subsequently, fourth paper setting direction determination processing that can be performed by the printing apparatus 111 is described. To realize the processing of the flowchart, the CPU 115 executes a program loaded from the ROM 113 into the RAM 114.

In step S301 illustrated in FIG. 6, the control processing unit 214 accesses the communication unit 212, and confirms whether a print job has been accepted. Subsequently, the processing proceeds to step S302 to step S304 illustrated in FIG. 6 and step S401 to step S402 illustrated in FIG. 8 although redundant description thereof will be avoided.

In step S402, the control processing unit 214 instructs the preview image combining unit 213 to generate a composite image that can be obtained by combining the pre-printed paper with the print job based on the pre-printed image, the paper setting direction, the paper size, and the paper feeding device number. The combination illustrated in the field 810 of FIG. 9 is used in the above-mentioned image combination. In the present exemplary embodiment, if the size of a print job image F is different from the size of a pre-printed image P, the preview image combining unit 213 enlarges the print job image F in such a manner that an upper left corner of the print job image coincides with an upper left corner of the pre-printed image before combining these images.

After the above-mentioned composite image data generation processing has been completed, the control processing unit 209 stores the composite image data in the memory unit 217. Then, the processing proceeds to step S403. Subsequently, the processing proceeds to step S404 although redundant description thereof will be avoided.

In step S404 illustrated in FIG. 8, the control processing unit 214 accesses the memory unit 217, and determines whether the image size of the accepted print job coincides with the paper size of the pre-printed paper. In the present exemplary embodiment, the pre-printed image size (i.e., “A3”) does not coincide with the print job image size (i.e., “A4”). Therefore, the operation of the control processing unit 214 proceeds to step S405.

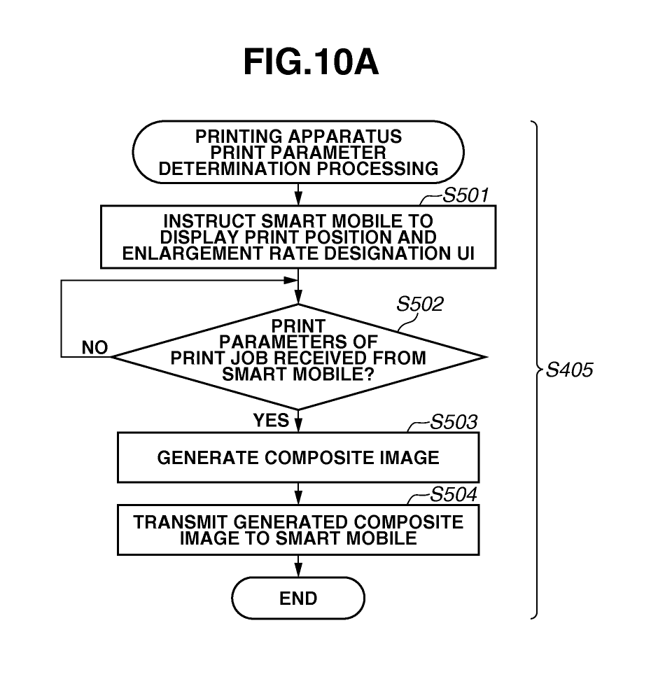

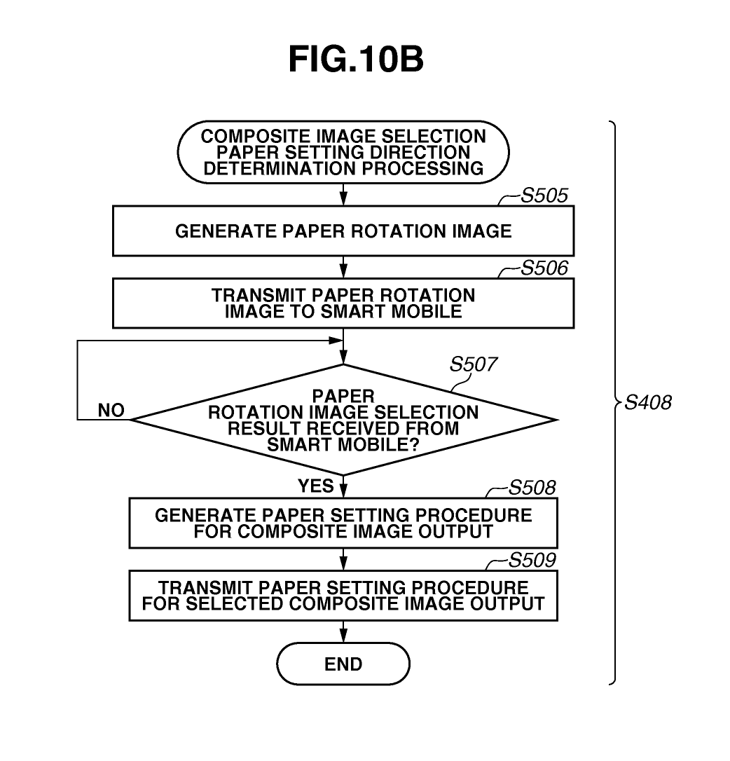

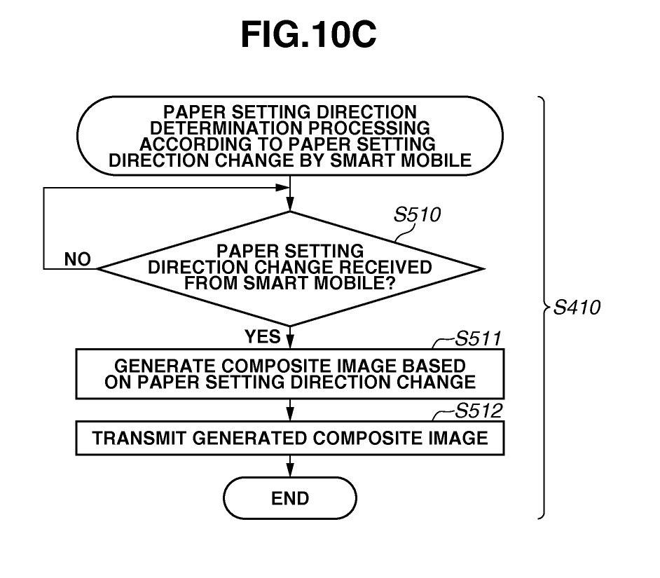

Hereinafter, processing to be performed in step S405 is described in detail below with reference to a flowchart illustrated in FIG. 10A.

FIGS. 10A, 10B, and 10C are flowcharts illustrating printing system control methods according to the present exemplary embodiment. To realize the processing in each step, the CPU 115 executes a program loaded from the ROM 113 into the RAM 114 in the printing apparatus 111. The printing apparatus performs image processing for generating a preview image corresponding to a print result on the pre-printed paper based on the image data received from the smart mobile 101 and the print information, as described below.

In step S501, the control processing unit 214 instructs the smart mobile 101 via the communication 212 to display the print position and enlargement rate designation UI. Subsequently, the operation of the control processing unit 214 proceeds to step S502. In step S502, the control processing unit 214 accesses the memory unit 217, and determines whether print parameters have been received from the smart mobile 101. If the control processing unit 214 determines that the print parameters have been received (YES in step S502), the processing proceeds to step S503. In step S503, the control processing unit 214 instructs the preview image combining unit 213 to generate a composite preview image based on the print parameters transmitted from the smart mobile 101.

For example, it is now presumed that the user performs a touch operation on the touch panel 108 along the arrow 1014 illustrated in FIG. 7E.

In this case, the control processing unit 214 updates the print parameters so that the print job image size can be equalized with the pre-printed paper size “A3”. The image composition rule to be used when the preview image combination is performed is the rule of a field 815 illustrated in FIG. 9. Subsequently, the control processing unit 214 stores the composite image data in the memory unit 217. Then, the processing proceeds to step S504. In step S504, the control processing unit 214 acquires the composite preview image from the memory unit 217, and instructs the communication unit 212 to transmit the acquired composite preview image to the smart mobile 101. Subsequently, the control processing unit 214 terminates the processing of the flowchart illustrated in FIG. 10A.

Subsequently, the processing proceeds to step S406 illustrated in FIG. 8, and the processing proceeds to step S305 in response to a print start command from the smart mobile 101, although redundant description thereof will be avoided.

Through the above-mentioned processing, when a user wants to set a pre-printed paper in a paper feeding device, the printing system can display a composite image of a pre-printed image and a print job image based on the pre-printed paper setting direction so that the user can confirm the correctness of the paper setting direction.

In a second exemplary embodiment, a printing system including a smart mobile and a printing apparatus can perform the following display control in a case where a preview image combined by the printing apparatus 111 does not indicate a printed product required by a user, as described below. More specifically, the display control that can be performed by the printing system according to the second exemplary embodiment includes displaying a direction along which a user should set a pre-printed paper in any one of the cassettes included in the paper feeding device unit 119 on the touch panel 108 of the smart mobile 101, as described below.

### <Paper Setting Direction Selection/Determination Processing by Smart Mobile>

First, paper setting direction selection/determination processing that can be performed by the smart mobile 101 is described below with reference to FIG. 4A and other drawings. To realize the processing of the flowchart, the CPU 104 executes a program loaded from the ROM 102 into the RAM 103.

In step S601 illustrated in FIG. 4A, if a user presses the print start button 903, the control processing unit 209 instructs the display processing unit 202 to display the selection screen 904 illustrated in FIG. 5A on the touch panel 108. Subsequently, if the user presses the YES button 905, the control processing unit 209 accesses the memory unit 204, and writes information indicating that the print job uses the pre-printed paper. Then, the processing proceeds to step S602. Hereinafter, if an operation performed by the user is similar to that in the second example described according to the first exemplary embodiment, the processing proceeds to step S603 to step S621 although redundant description thereof will be avoided.

In the present exemplary embodiment, the user operates the touch panel 108 and sets the direction of the pre-printed image 915 along the rotating operation acceptance direction illustrated in FIG. 5D. In this case, information indicating that the setting direction of the pre-printed paper in the cassette of the paper feeding device unit 119 is “SEF” and the print surface of the pre-printed paper is directed to the ceiling side, is stored in the memory unit 204. Subsequently, the processing proceeds to step S622. If the user operates the touch panel 108 and presses the finalization button 920 (YES in step S622), the operation of the control processing unit 209 proceeds to step S623. Subsequently, the processing proceeds from step S623 to step S624 and step S625 successively although redundant description thereof will be avoided.

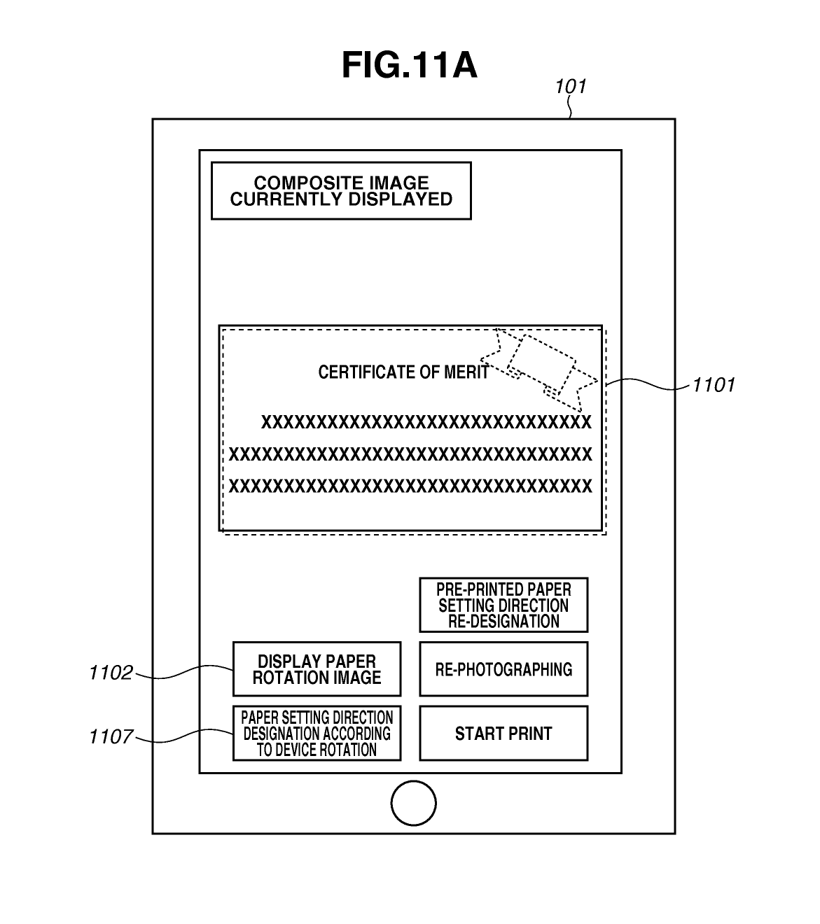

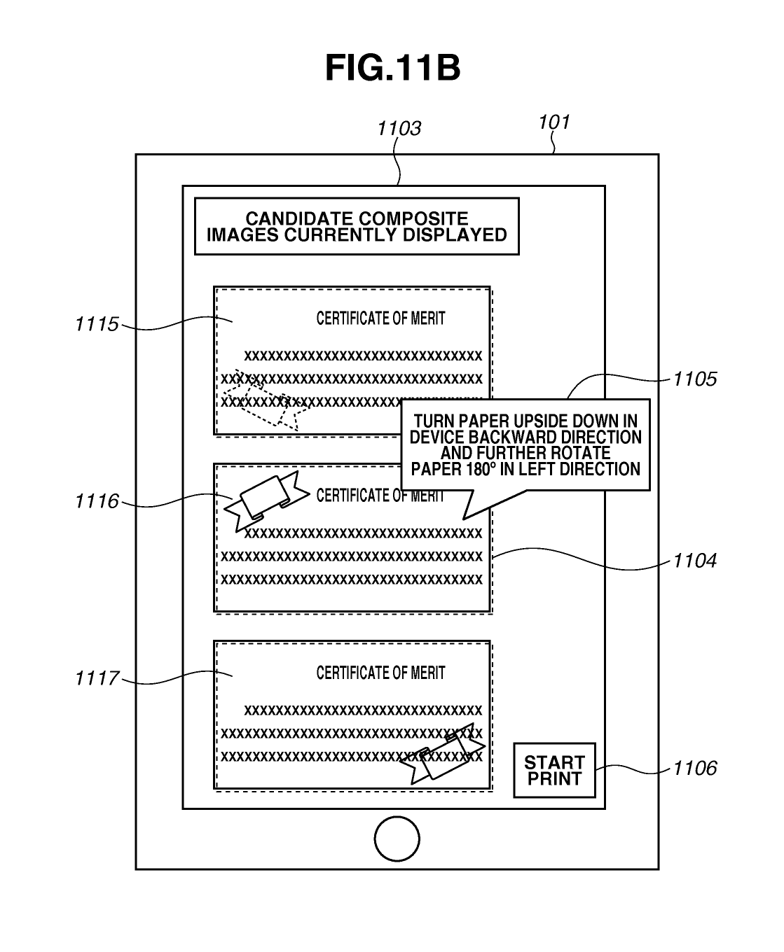

In step S625, the control processing unit 209 reads the composite image data from the memory unit 204, and instructs the display processing unit 202 to display a composite image 1101 on the touch panel 108 as illustrated in FIG. 11A.

FIGS. 11A and 11B illustrate examples of the UI screen that can be displayed on the smart mobile 101 according to the present exemplary embodiment.

In FIG. 11A, the composite image 1101 indicates that a print job image is printed on a surface facing the ceiling side in the state where the print surface of the pre-printed paper is directed to the ground side. After the control processing unit 209 completes the above-mentioned screen display operation, the processing proceeds to step S626. Subsequently, the processing successively proceeds to step S627 and step S629 although redundant description thereof will be avoided.

If the user presses a paper rotation image display button 1102 on the screen illustrated in FIG. 11A, the control processing unit 209 accesses the memory unit 204, and stores information indicating that the paper rotation image display button 1102 has been pressed. In step S629 illustrated in FIG. 4A, the control processing unit 209 accesses the memory unit 204, and confirms whether the paper rotation image display button 1102 has been pressed. If the control processing unit 209 determines that the paper rotation image display button 1102 has been pressed (YES in step S629), the processing proceeds to step S641.

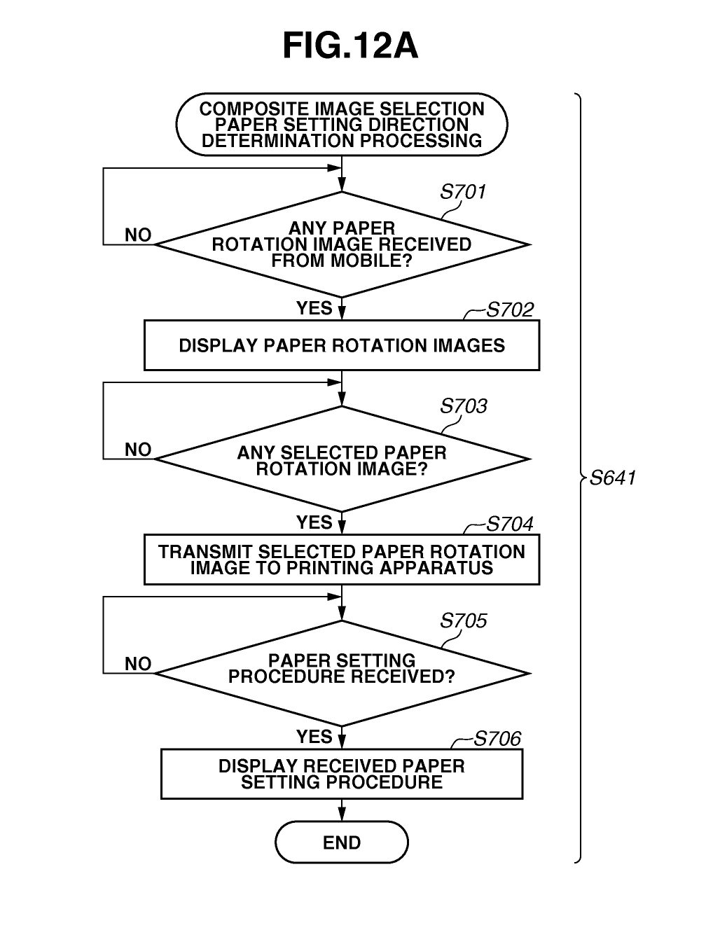

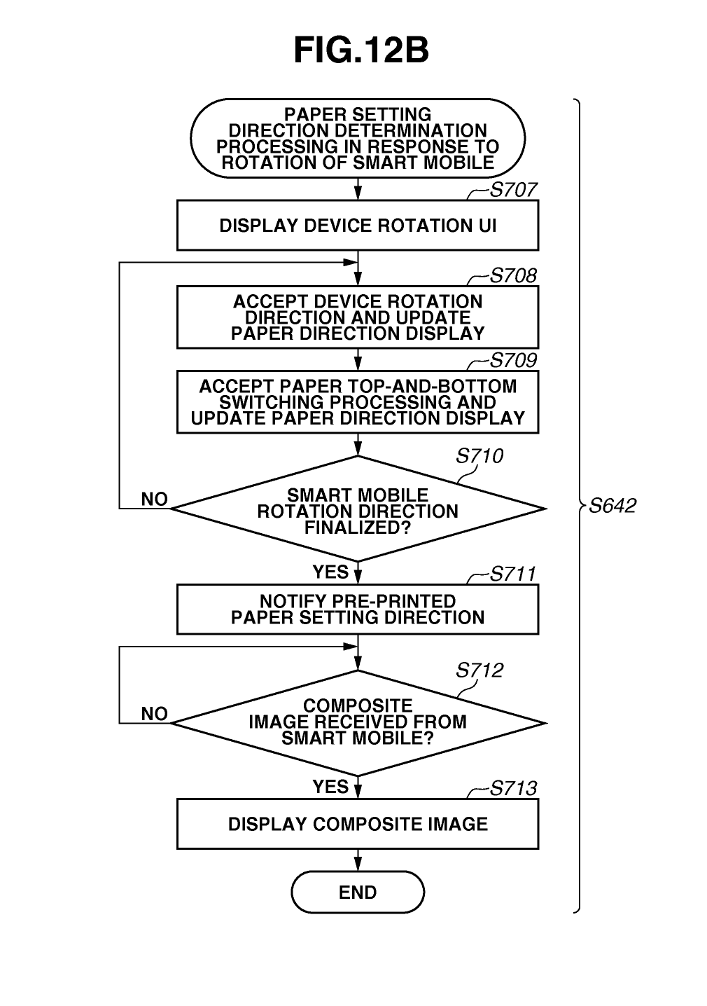

The processing to be performed in step S641 is described in detail below with reference to a flowchart illustrated in FIG. 12A.

FIGS. 12A and 12B are flowcharts illustrating a printing system control method according to the present exemplary embodiment. To realize the processing in each step, the CPU 104 executes a program loaded from the ROM 102 into the RAM 103.

In step S701, the control processing unit 209 accesses the memory unit 204, and determines whether a paper rotation image has been received from the printing apparatus 111. If the control processing unit 209 determines that the paper rotation image has been received (YES in step S701), the processing proceeds to step S702.

In step S702, the control processing unit 209 acquires paper rotation images from the memory unit 204, and instructs the display processing unit 202 to display the acquired paper rotation images on the touch panel 108. FIG. 11B illustrates a screen 1103 that includes the display of a plurality of paper rotation images. After the control processing unit 209 completes the above-mentioned screen display processing, the processing proceeds to step S703 illustrated in FIG. 12. On the screen illustrated in FIG. 11B, the user can select a desired paper rotation image by operating the touch panel 108. If the user touches a paper rotation image 1104, the control processing unit 209 accesses the memory unit 204, and stores information indicating that the paper rotation image 1104 has been selected.

Then, in step S703, the control processing unit 209 accesses the memory unit 204, and determines whether there is any selected paper rotation image. If the control processing unit 209 determines that there is the selected paper rotation image (YES in step S703), the processing proceeds to step S704. In step S704, the control processing unit 209 acquires the paper rotation image selected from the memory unit 204, and instructs the communication unit 207 to transmit the selected paper rotation image to the printing apparatus 111. Subsequently, the operation of the control processing unit 209 proceeds to step S705. In step S705, the control processing unit 209 accesses the memory unit 204, and determines whether a paper setting procedure has been received from the printing apparatus 111. In the present exemplary embodiment, the paper setting procedure from the printing apparatus 111 includes information indicating the necessity of changing the direction of the pre-printed paper in the cassette of the paper feeding device unit 119 to obtain a printed product corresponding to the previously selected paper rotation image. If the control processing unit 209 determines that the paper setting procedure has been received (YES in step S705), the processing proceeds to step S706. In step S706, the control processing unit 209 acquires the paper setting procedure from the memory unit 204, and instructs the display processing unit 202 to display the acquired paper setting procedure on the touch panel 108.

FIG. 11B illustrates a paper setting procedure 1105, which indicates that a printed product (corresponding to the paper rotation image 1104) can be obtained by turning the pre-printed paper indicated by the pre-printed image 915 upside down along the device back direction and further causing the pre-printed paper to rotate 180° in the left direction. A method for generating the paper setting procedure is described below. When the display processing unit 202 completes the display of the paper setting procedure 1105, the control processing unit 209 terminates the processing of the flowchart illustrated in FIG. 12A. Subsequently, the operation of the control processing unit 209 proceeds to step S630 illustrated in FIG. 4A. Subsequently, the user changes the paper setting direction of the pre-printed paper, and sets the pre-printed paper in the cassette of the paper feeding device unit 119. Then, if the user presses a print start button 1106, the processing proceeds from step S630 to step S631, step S632, step S627, and step S628 successively although redundant description thereof will be avoided.

### <Paper Setting Direction Selection/Determination Processing by Printing Apparatus>

Subsequently, paper setting direction selection/determination processing that can be performed by the printing apparatus 111 is described. To realize the processing of the flowchart, the CPU 115 executes a program loaded from the ROM 113 into the RAM 114.

In step S301 illustrated in FIG. 6, the control processing unit 214 accesses the memory unit 217, and determines whether a print job has been accepted. If the control processing unit 214 determines that the print job has been accepted (YES in step S301), the processing proceeds from step S301 to step S302, step S303, and step S304 successively and to step S401, step S402, step S403, step S404, and step S406 illustrated in FIG. 8. The processing to be performed in the above-mentioned steps has been already described, and therefore redundant description thereof will be avoided.

In step S406 illustrated in FIG. 8, the control processing unit 214 accesses the memory unit 217, and determines whether a print instruction has been received from the smart mobile 101. If the control processing unit 214 determines that there is not any print instruction received from the smart mobile 101 (NO in step S406), the processing proceeds to step S407. In step S407, the control processing unit 214 accesses the memory unit 217, and determines whether a paper rotating composite image has been requested by the smart mobile 101. If the control processing unit 214 determines that the composite image has been required (YES in step S407), the processing proceeds to step S408. Processing to be performed in step S408 is described in detail below with reference to the flowchart illustrated in FIG. 10B. In step S505, the control processing unit 214 instructs the preview image combining unit 213 to generate a paper rotating composite image.

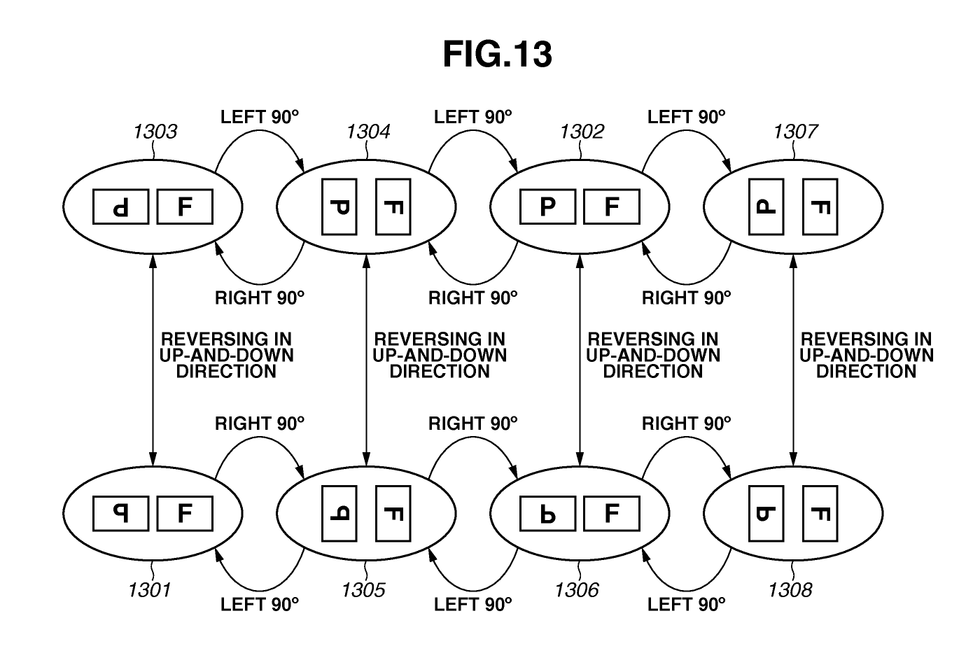

The generation of the paper rotating composite image according to the present exemplary embodiment is described in detail below with reference to FIG. 13.

FIG. 13 schematically illustrates composite image generation states that can be performed by the printing apparatus 111 illustrated in FIG. 1.

In FIG. 13, a rectangular image suffixed with “P” indicates the direction of the pre-printed paper. Further, in FIG. 13, a rectangular image suffixed with “F” indicates the top of a “Small group” print job image. Further, each ellipse indicates a combination of the direction of the pre-printed paper and the top of the Small group print job image. Further, each ellipse corresponds to the Small group image composition rule illustrated in FIG. 9.

For example, an ellipse 1301 corresponds to a pre-printed paper setting direction 813 illustrated in FIG. 9, and indicates an image composition rule applicable when a print job is a “Small group” landscape image and the setting direction of the pre-printed paper is “SEF” and the print surface of the pre-printed paper is directed to the ceiling side. When the smart mobile 101 requires a paper rotating composite image, the printing apparatus 111 generates a composite image according to one of the image composition rules indicated by the ellipses illustrated in FIG. 13 except for the image composition rule having been already used in the image composition. For example, it is now presumed that the image composition rule of the ellipse 1301 is used in generating a composite image in step S402, and the smart mobile 101 requires a paper rotating composite image.

In this case, the printing apparatus 111 can generate seven types of composite images of the “Small group” print job image and the pre-printed image using the image composition rules indicated by seven ellipses 1302 to 1308 (except for the ellipse 1301). After completing the above-mentioned generation of the composite images, the control processing unit 214 stores the generated composite images in the memory unit 217. Then, the processing proceeds to step S506.

In step S506 illustrated in FIG. 10B, the control processing unit 214 acquires the paper rotating composite image from the memory unit 217, and instructs the communication unit 212 to transmit the acquired paper rotating composite image to the smart mobile 101. Subsequently, the processing proceeds to step S507. If the printing apparatus 111 receives the selected paper rotation image from the smart mobile 101, the printing apparatus 111 stores the received paper rotation image in the memory unit 217. If the control processing unit 214 confirms that the paper rotation image has been stored in the memory unit 217 (YES in step S507), the processing proceeds to step S508.

In step S508, the control processing unit 214 generates a paper setting procedure to output a composite image. More specifically, the control processing unit 214 accesses the memory unit 217 and acquires the received paper rotation image. Further, the control processing unit 214 instructs the preview image combining unit 213 to analyze an image composition rule illustrated in FIG. 13 used to generate the acquired paper rotation image. More specifically, the preview image combining unit 213 analyzes that the selected paper rotation image 1104 has been generated based on the image composition rule indicated by the ellipse 1302.

Next, a paper setting procedure generation method for outputting the selected composite image is described below. The image composition rules required in the paper setting procedure generation are the image composition rule originally used in the generation of the composite image (corresponding to the ellipse 1301) and the image composition rule used in the generation of the paper rotation image transmitted from the smart mobile 101 (corresponding to the ellipse 1302).

In FIG. 13, each line connecting two ellipses defines a pre-printed paper reset (or reposition) direction. The paper setting procedure generation can be realized by combining pre-printed paper reset (or reposition) directions written together with connected lines when the image composition rule transits along arrows from the ellipse 1301 to the ellipse 1302. More specifically, to cause the image composition rule to transit from the ellipse 1301 to the ellipse 1302, it is necessary to pass along an image composition route including the ellipses 1301, 1303, 1304, and 1302. Therefore, the generated paper setting procedure indicates “setting the paper by reversing the paper upside down along the device back direction and rotating the paper 180° in the left direction”. Then, the control processing unit 214 stores the paper setting procedure generated in step S508 in the memory unit 217. The processing proceeds to step S509. In step S509, the control processing unit 214 acquires the paper setting procedure from the memory unit 217, and instructs the communication unit 212 to transmit the acquired paper setting procedure to the smart mobile 101. Subsequently, the control processing unit 214 terminates the processing of the flowchart illustrated in FIG. 10B. Subsequently, the processing proceeds to step S406. Hereinafter, if the user changes the paper setting direction and sets the paper in the paper feeding device and further presses the print start button 1106, the processing proceeds from step S406 to step S305 although redundant description thereof will be avoided.

As described above, when it is necessary to reset a pre-printed paper, the printing system according to the present exemplary embodiment can reduce the work for repetitively resetting (or repositioning) the pre-printed paper by displaying a printed product that can be obtained when the pre-printed paper is reset (or repositioned).

In a third exemplary embodiment, a printing system including a smart mobile and a printing apparatus can perform the following processing for enabling a user to rotate the smart mobile to designate the paper setting direction in a case where a preview image combined by the printing apparatus does not indicate a printed product required by the user, as described below.

### <Paper Setting Direction Determination Processing According to Rotation of Smart Mobile>

First, paper setting direction determination processing that can be performed by the smart mobile is described below. To realize the processing of the flowchart, the CPU 104 executes a program loaded from the ROM 102 into the RAM 103.

In step S601 illustrated in FIG. 4A, if a user presses the print start button 903, the control processing unit 209 instructs the display processing unit 202 to display the selection screen 904 illustrated in FIG. 5A on the touch panel 108.

Subsequently, if the user presses the YES button 905, the control processing unit 209 accesses the memory unit 204, and writes information indicating that the print job uses the pre-printed paper. Then, the processing proceeds to step S602. Hereinafter, if an operation performed by the user is similar to that in the second example described in the first exemplary embodiment, the processing proceeds to step S603 to step S621 although redundant description thereof will be avoided.

In the present exemplary embodiment, the user operates the touch panel 108 and sets the direction of the pre-printed image along the paper setting acceptance direction illustrated in FIG. 5D. In this case, information indicating that the setting direction of the pre-printed paper in the paper feeding device is “SEF” and the print surface of the pre-printed paper is directed to the ceiling side, is stored in the memory unit 204. Subsequently, the processing proceeds to step S622. If the user operates the touch panel 108 and presses the finalization button 1009 (YES in step S622), the operation of the control processing unit 209 proceeds to step S623.

Subsequently, the processing proceeds to step S623 illustrated in FIGS. 4C-A and to step S624 and step S625 illustrated in FIG. 4A although redundant description thereof will be avoided. In step S625, the control processing unit 209 reads the composite image from the memory unit 204, and instructs the display processing unit 202 to display the composite image 1101 on the touch panel 108 as illustrated in FIG. 11A.

In FIG. 11A, the composite image 1101 indicates that a print job image is printed on a surface facing the ceiling side in the state where the print surface of the pre-printed paper is directed to the ground side. After the control processing unit 209 completes the above-mentioned screen display operation, the processing proceeds to step S626. Subsequently, the processing successively proceeds to step S629 and step S630 although redundant description thereof will be avoided.

If the user presses a “paper setting direction designation according to device rotation” button 1107 for the composite image 1101 on the screen illustrated in FIG. 11A, the control processing unit 209 accesses the memory unit 204, and stores information indicating that the “paper setting direction designation according to device rotation” button 1107 has been pressed. In step S630, the control processing unit 209 accesses the memory unit 204 and confirms whether the “paper setting direction designation according to device rotation” button 1107 has been pressed. If the control processing unit 209 determines that the “paper setting direction designation according to device rotation” button 1107 has been pressed (YES in step S630), the processing proceeds to step S642.

The processing to be performed in step S642 illustrated in FIG. 4A is described in detail below with reference to a flowchart illustrated in FIG. 12B.

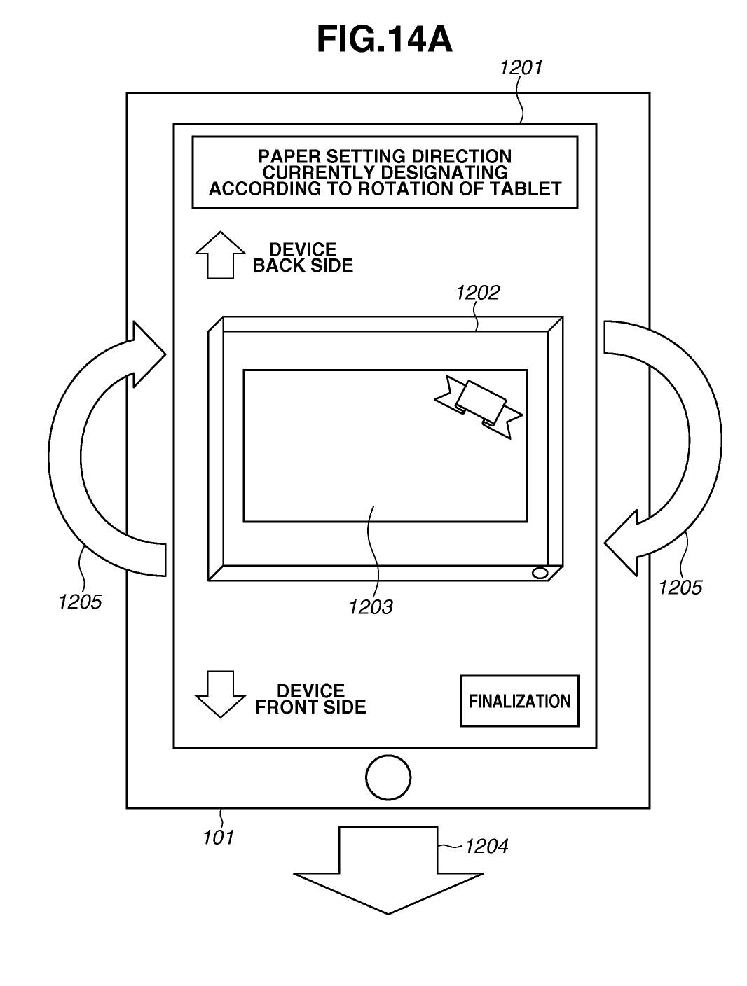

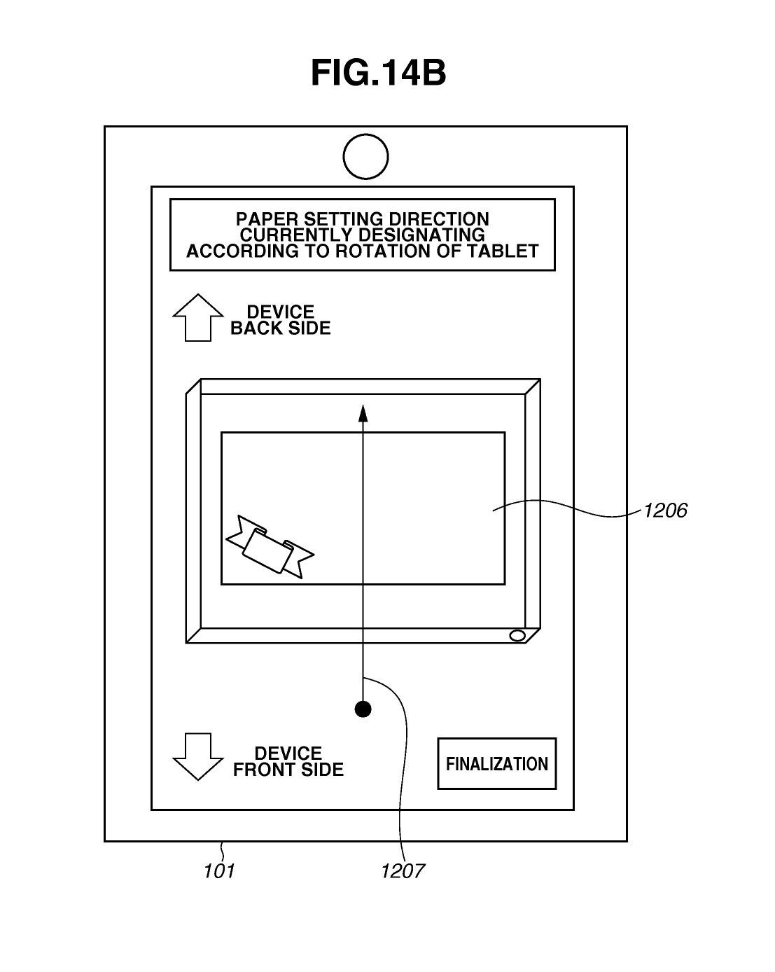

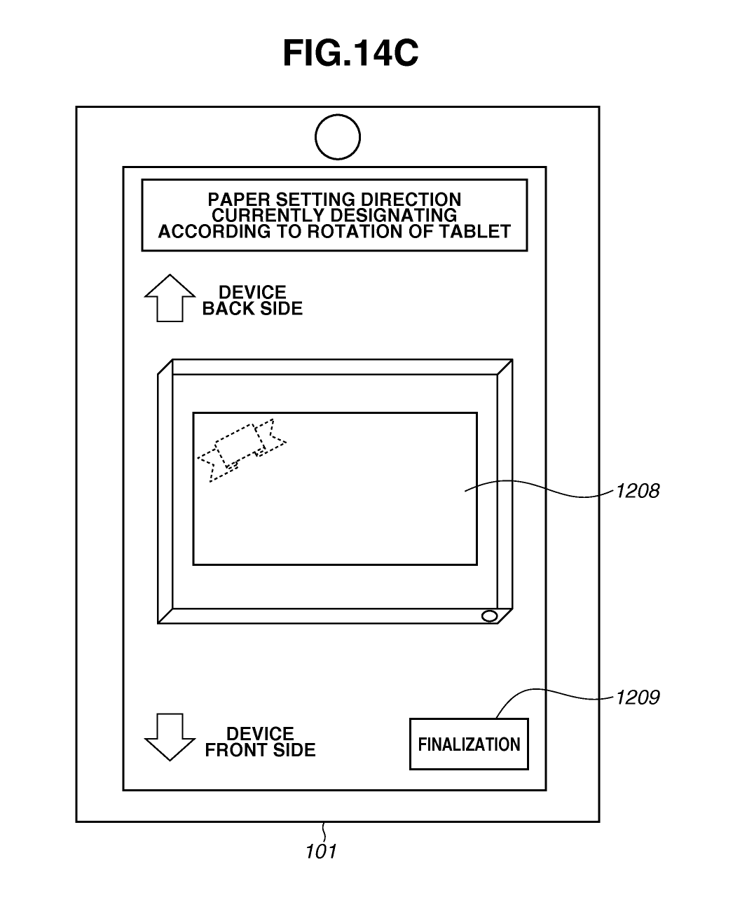

In step S707, the control processing unit 209 instructs the display processing unit 202 to display a device rotation UI 1201 on the touch panel 108 in association with device information (i.e., information about the type of a cassette accommodated in the printing apparatus) as illustrated in FIG. 14A.

In FIG. 14A, a cassette 1202 indicates an image of the paper feeding device viewed just above, which corresponds to the selected paper feeding device unit 119. Further, the device rotation UI 1201 includes a pre-printed image 1203. When the control processing unit 209 completes the above-mentioned screen display operation, the processing proceeds to step S708.

In step S708, the control processing unit 209 instructs the acceleration detection unit 208 to measure a change occurring in acceleration. In FIG. 14A, a direction 1204 indicates the gravity direction of the smart mobile 101. More specifically, the direction 1204 indicates the ground side. In this case, if the user rotates the smart mobile 101 along arrows 1205, the acceleration detection unit 208 stores the measured change in the gravitational acceleration in the memory unit 204. Further, the control processing unit 209 changes and displays the direction of the pre-printed image 1203 based on the measured change in the gravitational acceleration. FIG. 14B illustrates a direction-changed pre-printed image 1206. Subsequently, the operation of the control processing unit 209 proceeds to step S709. If the user moves a finger along an arrow 1207 on the touch panel 108, the control processing unit 209 accesses the memory unit 204, and displays an image that can be obtained by turning the pre-printed image upside down along the device back direction.

More specifically, the control processing unit 209 acquires image data of the captured pre-printed paper, and instructs the display processing unit 202 to display a pre-printed image 1208 (i.e., a pre-printed image seen from the back side) on the touch panel 108 as illustrated in FIG. 14C. When the control processing unit 209 completes the above-mentioned pre-printed image display operation, the processing proceeds to step S710. If the user presses a finalization button 1209, the control processing unit 209 accesses the memory unit 204, and stores information indicating that the finalization button 1209 has been pressed. In step S710, the control processing unit 209 accesses the memory unit 204, and confirms whether the finalization button 1209 has been pressed. If the control processing unit 209 confirms the pressing of the finalization button (YES in step S710), the processing proceeds to step S711.

In step S711, the control processing unit 209 acquires a change in the paper setting direction from the memory unit 204, and instructs the communication unit 207 to transmit the acquired paper setting direction to the smart mobile 101. Subsequently, the processing proceeds to step S712.

In step S712, the control processing unit 209 accesses the memory unit 204, and determines whether there is any composite image received from the smart mobile 101. If the control processing unit 209 confirms the composite image received from the smart mobile 101 (YES in step S712), the processing proceeds to step S713. In step S713, the control processing unit 209 acquires the composite image from the memory unit 204, and instructs the display processing unit 202 to display the composite image on the touch panel 108. Then, the control processing unit 209 terminates the processing of the flowchart illustrated in FIG. 12B. Subsequently, the processing returns to step S631 illustrated in FIG. 4A although redundant description of the following processing will be avoided.

### <Paper Setting Direction Determination Processing by Printing Apparatus According to Rotation of Smart Mobile>

Subsequently, paper setting direction determination processing that can be performed by the printing apparatus 111 according to the rotation of the smart mobile 101 is described. To realize the processing of the flowchart, the CPU 115 executes a program loaded from the ROM 113 into the RAM 114.

In step S301 illustrated in FIG. 6, the control processing unit 214 accesses the memory unit 217, and determines whether a print job has been accepted. If the control processing unit 214 determines that the print job has been accepted (YES in step S301), the processing proceeds from step S301 to step S302, step S303, and step S304 successively illustrated in FIG. 6 and to step S401, step S402, step S403, step S404, and step S406 illustrated in FIG. 8. The processing to be performed in the above-mentioned steps has been already described, and therefore redundant description thereof will be avoided.

Then, in step S406 illustrated in FIG. 8, the control processing unit 214 accesses the memory unit 217, and confirms whether a print instruction has been received from the smart mobile 101. If the control processing unit 214 determines that there is not any print instruction received from the smart mobile 101 (NO in step S406), the processing proceeds to step S407.

In step S407, the control processing unit 214 accesses the memory unit 217, and confirms whether a paper rotating composite image has been requested by the smart mobile 101. If the control processing unit 214 determines that there is not any composite image required by the smart mobile 101 (NO in step S407), the processing proceeds to step S409. In step S409, the control processing unit 214 accesses the memory unit 217, and determines whether changing the paper setting direction according to the rotation and operation of the smart mobile 101 has been instructed. If the control processing unit 214 determines that the above-mentioned paper setting direction change has been instructed (YES in step S409), the processing proceeds to step S410. Processing to be performed in step S410 is described in detail below with reference to the flowchart illustrated in FIG. 10C.

In step S510, the control processing unit 214 determines whether the paper setting direction change has been received from the smart mobile 101. If the control processing unit 214 determines that the paper setting direction change has been received (YES in step S510), the processing proceeds to step S511.

In step S511, the control processing unit 214 performs processing for combining the pre-printed image with the print job image based on the changed paper setting direction. Image combination processing to be performed in this case is described below. First, the image composition rule used when the composite image is generated in step S402 is the pre-printed paper setting direction 813 in the database DB illustrated in FIG. 9. Further, the paper setting direction change information received from the smart mobile 101 in step S510 includes a description about “rotating the paper setting direction 180° in the right direction and further turning the paper upside down along the device back direction”. The control processing unit 214 finalizes the image composition rule based on the paper setting direction change information. More specifically, a state transition of the image composition rule 813 occurs from the composite image 1101 illustrated in FIG. 11A to the composite images 1101, 1115, 1116, and 1117 successively according to the paper setting direction change information. In this case, the rule to be used in the generation of the composite image is the rule 813 corresponding to the paper rotation image display button 1102. The control processing unit 214 instructs the preview image combining unit 213 to generate a composite image using the image composition rule 813.

After the control processing unit 214 stores the composite image in the memory unit 217, the processing proceeds to step S512. In step S512, the control processing unit 214 acquires the composite image from the memory unit 217, and instructs the communication unit 212 to transmit the acquired composite image to the smart mobile 101. Subsequently, the control processing unit 214 terminates the processing of the flowchart illustrated in FIG. 10C. Then, the processing proceeds to step S411 and subsequent steps although redundant description thereof will be avoided.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-213595 filed Oct. 11, 2013, which is hereby incorporated by reference herein in its entirety.

What is claimed is:

1. A printing system in which a mobile terminal can communicate with a printing apparatus that includes a plurality of paper feeding units capable of storing pre-printed papers, wherein
the mobile terminal comprises:
an imaging unit;
a storage unit configured to store image data of a pre-printed paper captured by the imaging unit and stored in a paper feeding unit together with a print job to be printed;
an acceptance unit configured to accept paper settings for the pre-printed paper via a display screen;
a transmission unit configured to transmit the image data of the pre-printed paper stored in the storage unit, the paper settings for the pre-printed paper, and the print job to the printing apparatus;
a reception unit configured to receive composite image data, which is obtained by combining the pre-printed paper image data with print data generated from the print job, from the printing apparatus; and
a display control unit configured to display the composite image data received from the printing apparatus on a display screen,
the printing apparatus comprises:
a generation unit configured to generate print data to be printed based on a print job received from the mobile terminal;
an image processing unit configured to generate composite image data by combining the print data generated by the generation unit with image data of a pre-printed paper transmitted from the mobile terminal; and
a transfer unit configured to transfer the composite image data generated by the image processing unit to the mobile terminal.

2. The printing system according to claim 1, wherein the acceptance unit is configured to accept the paper settings for the pre-printed paper to be displayed on the display screen according to a rotational movement of the mobile terminal body or a touch operation on the display screen.

3. The printing system according to claim 2, wherein the acceptance unit is configured to accept the paper settings for the pre-printed paper in association with device information that identifies the type of the paper feeding unit provided in the printing apparatus.

4. The printing system according to claim 2, wherein the acceptance unit is configured to accept information about paper size and paper feeding unit required to store the pre-printed paper in the printing apparatus in association with the display screen.

5. The printing system according to claim 2, wherein the acceptance unit is configured to accept a zooming instruction applied to image information to be printed in association with the pre-printed paper displayed on the display screen.

6. The printing system according to claim 1, wherein the display control unit is configured to display a setting procedure acquired from the printing apparatus, to set the pre-printed paper in the paper feeding unit in association with the composite image displayed on the display screen.

7. The printing system according to claim 1, wherein a paper feeding unit that stores the pre-printed paper is determined when a paper feeding unit displayed on the display screen is selected in association with information identifying each paper feeding unit included in the printing apparatus.

8. The printing system according to claim 1, wherein the size of a pre-printed paper stored in any one of the paper feeding units is determined when a size displayed on the display screen is selected in association with information identifying each paper feeding unit included in the printing apparatus.

9. The printing system according to claim 1, wherein the direction of a pre-printed paper stored in any one of the paper feeding units can be determined in response to an operation to instruct a pre-printed paper image displayed on the display screen in association with information identifying each paper feeding unit included in the printing apparatus.

10. The printing system according to claim 1, wherein the paper feeding unit is configured to store the pre-printed paper in a state where a non-printed surface is directed to an upper side.

11. The printing system according to claim 1, wherein the paper feeding unit is configured to store the pre-printed paper in such a way as to set a longitudinal direction of the pre-printed paper to be a paper feeding direction.

12. The printing system according to claim 1, wherein the paper feeding unit is configured to store the pre-printed paper in such a way as to set a short-side direction of the pre-printed paper to be a paper feeding direction.

13. A mobile terminal that can communicate with a printing apparatus including a plurality of paper feeding units capable of storing pre-printed papers, the mobile terminal comprising:
an imaging unit;
a storage unit configured to store image data of a pre-printed paper captured by the imaging unit and stored in a paper feeding unit together with a print job to be printed;
an acceptance unit configured to accept paper settings for the pre-printed paper via a display screen;
a transmission unit configured to transmit the image data of the pre-printed paper stored in the storage unit, the paper settings for the pre-printed paper, and the print job to the printing apparatus;
a reception unit configured to receive composite image data, which is obtained by combining the pre-printed paper image data with print data generated from the print job, from the printing apparatus; and
a display control unit configured to display the composite image data received from the printing apparatus on a display screen.

14. A printing apparatus including a plurality of paper feeding units capable of storing printing papers, the printing apparatus comprising:
a communication unit configured to communicate with a mobile terminal;
a generation unit configured to generate print data to be printed based on a print job received from the mobile terminal;
an image processing unit configured to generate composite image data by combining the print data generated by the generation unit with image data of a pre-printed paper transmitted from the mobile terminal; and
a transfer unit configured to transfer the composite image data generated by the image processing unit to the mobile terminal.

15. A method for controlling a mobile terminal that can communicate with a printing apparatus including a plurality of paper feeding units capable of storing pre-printed papers, the method comprising:
storing in a storage unit image data of a pre-printed paper captured by an imaging unit and stored in a paper feeding unit together with a print job to be printed;
accepting paper settings for the pre-printed paper via a display screen;
transmitting the image data of the pre-printed paper stored in the storage unit, the paper settings for the pre-printed paper, and the print job to the printing apparatus;
receiving composite image data, which is obtained by combining the pre-printed paper image data with print data generated from the print job, from the printing apparatus; and
displaying the composite image data received from the printing apparatus on a display screen.

16. A method for controlling a printing apparatus including a plurality of paper feeding units capable of storing printing papers, the method comprising:
generating print data to be printed based on a print job received from a mobile terminal;
generating composite image data by combining the generated print data with image data of a pre-printed paper transmitted from the mobile terminal; and
transferring the generated composite image data to the mobile terminal.

17. A computer readable storage medium storing a program for causing a computer of a mobile terminal that can communicate with a printing apparatus including a plurality of paper feeding units capable of storing pre-printed papers to execute a control method of the mobile terminal, the control method comprising:
storing in a storage unit image data of a pre-printed paper captured by an imaging unit and stored in a paper feeding unit together with a print job to be printed;
accepting paper settings for the pre-printed paper via a display screen;
transmitting the image data of the pre-printed paper stored in the storage unit, the paper settings for the pre-printed paper, and the print job to the printing apparatus;
receiving composite image data, which is obtained by combining the pre-printed paper image data with print data generated from the print job, from the printing apparatus; and
displaying the composite image data received from the printing apparatus on a display screen.

18. A computer readable storage medium storing a program for causing a computer to execute a method for controlling a printing apparatus including a plurality of paper feeding units capable of storing printing papers, the method comprising:
generating print data to be printed based on a print job received from a mobile terminal;
generating composite image data by combining the generated print data with image data of a pre-printed paper transmitted from the mobile terminal; and
transferring the generated composite image data to the mobile terminal.
